(19) United States
(12) Patent Application Publication
(10) Pub. No.: US 2010/0080909 A1
(43) Pub. Date: Apr. 1, 2010

(54) INKJET RECORDING METHOD

(75) Inventor: Ryoichi NAKANO, Shizuoka-ken (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/562,146

(22) Filed: Sep. 18, 2009

(30) Foreign Application Priority Data
Sep. 30, 2008 (JP) 2008-254013

(51) Int. Cl. B05D 5/06

(52) U.S. Cl. 427/256

(57) ABSTRACT

The present invention provides an inkjet recording method including ejecting an ink onto an ink receiving layer provided on a support to perform recording, wherein the ink receiving layer includes an inorganic fine particle (P) and a polyvinyl alcohol-based resin (B) at a content ratio (P/B; mass ratio) of from 3 to 5, and a water-soluble aluminum compound, and the ink receiving layer has a moisture amount at recording of 1.2 g/m² or less, using which a recorded image excellent in water resistance is obtained, and generation of bronzing of an image may be stably suppressed.

### CROSS-REFERENCE TO RELATED APPLICATION

This application claims priority under 35 USC 119 from Japanese Patent Application No. 2008-254013 filed on Sep. 30, 2008, the disclosure of which is incorporated by reference herein.

### BACKGROUND OF THE INVENTION

1. Field of the Invention

The present invention relates to an inkjet recording method of ejecting an ink by an inkjet method to perform recording.

2. Related Art

As an image recording method of recording an image, in recent years, a variety of methods have been proposed, but requirements with respect to quality of a recorded material such as quality of an image are high in any of these methods. For example, as an inkjet recording method, a method of using a recording medium for inkjet recording in which a recording layer for receiving an ink is constructed to be a porous structure, has been put into practice.

As properties required for such a recording medium, generally, in addition to quick drying (a high ink absorbing rate), for example, suitability and uniformity of a diameter of an ink dot (no blur), good water resistance at an image portion, and good storability with no blurring of an image are required.

As one example of a recording medium having a porous structure, a recording medium for inkjet recording in which a recording layer having a high void rate is provided on a support by using an inorganic pigment particle and a water-soluble binder, is proposed. Since this recording medium has a high void rate, the medium has high absorption of an ink and rapid drying properties.

Although high ink absorption is important as a recording property, since a recording layer with a porous structure having a high void rate has a great area of contact with atmospheric air and has a nature such that it easily absorbs moisture, even when stored under an environmental condition of a relatively low humidity, an amount of moisture in the recording layer is increased, and it becomes difficult to absorb an ink, in comparison with plain paper and coated paper.

As a technique associated therewith, an inkjet recording method of inkjet printing on a recording medium in a state where an amount of moisture in the recording medium, which is a paper medium, has been adjusted in advance to be less than or equal to an equilibrium moisture amount at a temperature and humidity at printing, has been disclosed (see, for example, Japanese Patent Application Laid-Open (JP-A) No. 2008-68462), and it is described that drying is rapid, and image density unevenness is reduced.

On the other hand, in order to improve water resistance and image blur resistance of an image after recording, a technique of using a water-soluble metal compound such as a water-soluble aluminum compound, or a cationic compound in a recording layer is known.

### SUMMARY

According to an aspect of the invention, there is provided an inkjet recording method including ejecting an ink onto an ink receiving layer provided on a support to perform recording, wherein the ink receiving layer includes an inorganic fine particle (P) and a polyvinyl alcohol-based resin (B) at a content ratio (P/B; mass ratio) of from 3 to 5, and a water-soluble aluminum compound, and the ink receiving layer has a moisture amount at recording of 1.2 g/m² or less, using which is a recorded image excellent in water resistance is obtained, and generation of bronzing of an image can be stably suppressed.

### BRIEF DESCRIPTION OF THE DRAWINGS

Exemplary embodiments of the present invention will be described in detail based on the following FIGURE, wherein:

FIG. 1 is a schematic cross-sectional view showing one example of the drying unit for inducing a dry air stream.

### DETAILED DESCRIPTION

Exemplary embodiments of the invention are described in detail hereinafter. As described above, when a moisture content of a recording layer to which droplets of an ink are adhered is increased, and it becomes difficult to absorb an ink, so-called bronzing is easily caused, in some cases, in which an image (e.g., solid image) dazzles bronze.

In a recording medium in which a recording layer of a porous structure having a high void rate (also referred to as “porosity” in some cases) is provided, even when stored at a low humidity, a moisture content in the recording layer is increased in a relatively short time, bronzing easily generates in an image and, even when a moisture amount is adjusted to be less than or equal to an equilibrium moisture amount like the conventional inkjet recording method, the improving effect is not sufficiently obtained. In addition, when one tries to use a water-soluble metal compound such as a water-soluble aluminum compound for improving water resistance in a composition having a large amount of a binder, it is thought that the effects of improving water resistance and image blur resistance are obtained to some extent, but, bronzing property of an image is easily deteriorated, and bronzing becomes remarkable particularly when the recording medium after recording is put under a high humidity.

The invention was done in view of the above circumstances, and an object of the invention is to provide an inkjet recording method using which a recorded image excellent in water resistance and, at the same time, good in surface state is obtained, and generation of bronzing of an image can be stably suppressed. The objects to solve the problems may be achieved by items <1> to <10> shown below.

<1> An inkjet recording method including ejecting an ink onto an ink receiving layer provided on a support to perform recording, wherein the ink receiving layer includes an inorganic fine particle (P) and a polyvinyl alcohol-based resin (B) at a content ratio (P/B; mass ratio) of from 3 to 5, and a water-soluble aluminum compound, and the ink receiving layer has a moisture amount at recording of 1.2 g/m² or less.

<2> The inkjet recording method of the item <1>, wherein the ink is ejected at a maximum total ink ejection amount of 15 g/m² or more.

<3> The inkjet recording method of the item <1> or <2>, wherein the ink includes at least a water-soluble phthalocyanine dye represented by the following Formula (C-1).

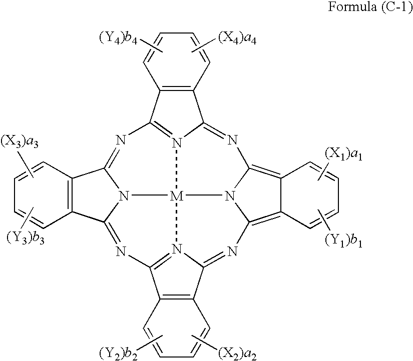

In Formula (C-1), each of X₁, X₂, X₃ and X₄ independently represents any of —SO—Z, —SO₂—Z, —SO₂NV₁V₂, —CONV₁V₂, —CO₂Z, —CO—Z, or a sulfo group; Z each independently represents an alkyl group, a cycloalkyl group, an alkenyl group, an alkynyl group, an aralkyl group, an aryl group, or a heterocyclic group; V₁ and V₂ each independently represent a hydrogen atom, an alkyl group, a cycloalkyl group, an alkenyl group, an alkynyl group, an aralkyl group, an aryl group, or a heterocyclic group; Y₁, Y₂, Y₃ and Y₄ each independently represent a hydrogen atom, a halogen atom, an alkyl group, a cycloalkyl group, an akenyl group, an aralkyl group, an aryl group, a heterocyclic group, a cyano group, a hydroxy group, a nitro group, an amino group, an alkylamino group, an alkoxy group, an aryloxy group, an amido group, an arylamino group, a ureido group, a sulfamoylamino group, an alkylthio group, an arylthio group, an alkoxycarbonylamino group, a sulfonamido group, a carbamoyl group, a sulfamoyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imido group, a heterocyclic thio group, a phosphoryl group, an acyl group, or an ionic hydrophilic group; a₁ to a₄ and b₁ to b₄ respectively represent numbers of X₁ to X₄ and Y₁ to Y₄; each of a₁ to a₄ independently represents an integer of from 0 to 4, provided that all of a₁ to a₄ do not represent 0 at the same time; each of b₁ to b₄ independently represents an integer of from 0 to 4; M represents a hydrogen atom, a metal atom or an oxide thereof, a hydroxide thereof, or a halide thereof; and at least one of X₁, X₂, X₃, X₄, Y₁, Y₂, Y₃ or Y₄ represents an ionic hydrophilic group, or a group having an ionic hydrophilic group as a substituent.

<4> The inkjet recording method of any one of items <1> to <3>, wherein the ink receiving layer further includes a crosslinking agent, and the ink receiving layer is a porous layer cured by a crosslinking reaction between the crosslinking agent and a water-soluble resin containing the polyvinyl alcohol-based resin.

<5> The inkjet recording method of any one of items <1> to <4>, wherein the inorganic fine particle is selected from the group consisting of a silica fine particle, a colloidal silica, an alumina fine particle and pseudoboehmite.

<6> The inkjet recording method of any one of items <1> to <5>, wherein the inorganic fine particle is vapor-phase process silica, and the polyvinyl alcohol-based resin is a polyvinyl alcohol-based resin having a saponification degree of 70% to 100%.

<7> The inkjet recording method of any one of items <1> to <6>, wherein a solid matter content of the inorganic fine particle in the ink receiving layer is 50% by mass or more.

<8> The inkjet recording method of any one of items <1> to <7>, wherein the ink receiving layer further contains at least one nitrogen-containing organic cationic polymer.

<9> The inkjet recording method of the item <4>, wherein the crosslinking agent is a boron compound.

<10> The inkjet recording method of any one of items <1> to <9>, wherein the ink is ejected within 30 seconds after the ink receiving layer is dried to the extent that moisture does not substantially remain therein.

The inkjet recording method of the invention will be explained in detail below.

The inkjet recording method of the invention has a feature of using an inkjet recording medium having, on a support, an ink receiving layer including an inorganic fine particle, a polyvinyl alcohol-based resin and a water-soluble aluminum compound, a content ratio of the inorganic fine particle (P) to the polyvinyl alcohol-based resin (B) (P/B [mass ratio]; hereinafter, also referred to as “PB ratio”) being from 3 to 5, and having a moisture amount at recording of 1.2 g/m² or less; and ejecting an ink onto the ink receiving layer to perform recording.

In the invention, upon ejection of an ink onto the ink receiving layer by the inkjet method, the PB ratio of the inorganic fine particle and the polyvinyl alcohol-based resin in the ink receiving layer to which droplets of the ink are to be adhered is in a relatively narrow range to be good in surface state and porous, a water-soluble aluminum compound is further used together, and a moisture amount of the ink receiving layer at recording is suppressed to 1.2 g/m² or less, and recording is performed, thereby, adverse influence of the water-soluble aluminum compound on bronzing may be suppressed, therefore, generation of bronzing of an image may be suppressed while water resistance is retained high.

The recording mode using the inkjet method which is a method for image recording on an inkjet recording media by the inkjet recording method of the present invention, is not specifically limited, and known modes such as an electric charge controlling mode in which an ink is jetted by utilizing electrostatic attracting force, a drop-on-demand mode that utilizes oscillation pressure of a piezo element (pressure pulse mode), an acoustic inkjet mode in which an electric signal is converted to an acoustic beam and an ink is jetted by irradiating the acoustic beam to the ink and utilizing the radiation pressure, a thermal inkjet (bubble jet (registered trademark)) mode that utilizes the pressure generated upon formation of bubbles by heating an ink, or the like may be used. Specific inkjet method is the method described in JP-A No. 54-59936, in which the volume of the ink is rapidly changed by the action of heat energy and the ink is jetted from a nozzle by the action of this state change, may be effectively used.

The inkjet method also includes a mode of jetting a number of inks having a low concentration, which is referred to as a photo ink, with a small volume, a mode of improving image quality using a plurality of inks having substantially the same hues and different concentration, and a mode using a colorless and transparent ink.

The inkjet head used in the inkjet method may be of an on-demand mode or continuous mode. Furthermore, specific examples of the jetting mode may include an electromechanical converting mode (e.g., a single cavity type, a double cavity type, a vendor type, a piston type, a share mode type, a shared wall type or the like), an electric-thermal converting mode (e.g., a thermal inkjet type, a bubble jet (registered trademark) type or the like), an electrostatic drawing mode (e.g., an electric field control type, a slit jet type or the like), a discharging mode (e.g., a spark jet type or the like), and the like, and any jetting mode may be used.

The ink nozzle and the like used in the recording by the inkjet method are not specifically limited, and may be suitably selected according to the purpose.

As the inkjet head, a shuttle mode in which recording is carried out by using a short serial head while the head is scanned in the direction of the width of the recording medium, as well as a line mode using a line head in which recording elements are arranged according to the whole area of one side of the recording medium may be applied. In the line mode, image recording may be performed on the whole surface of the recording medium by scanning the recording medium in the direction orthogonal to the direction of the arrangement of the recording elements, and a recording speed higher than that of the shuttle mode may be realized since only the recording medium moves.

In addition, the recording system by the inkjet method includes a system of ejecting a number of inks having a low concentration, which is called a photo ink, with a small volume, a system of improving image quality using a plurality of inks having substantially the same hue and a different concentration, and a system of using a colorless and transparent ink.

Upon ejection of an ink by the inkjet method, an ink is ejected onto an ink receiving layer having a moisture amount of 1.2 g/m² or less to record an image. When the ink receiving layer at recording has a moisture amount more than 1.2 g/m², occurrence of bronzing of an image may not be suppressed. From the viewpoint of more suppression of occurrence of bronzing, a moisture amount of the ink receiving layer is preferably 0.8 g/m² or less. From the viewpoint of more avoidance of cracking after coating and drying, a lower limit of the moisture amount of the ink receiving layer is preferably 0.2 g/m².

A moisture amount of the ink receiving layer is measured by drying the inkjet recording medium in which an ink receiving layer is provided on a support, to the extent that moisture does not substantially remain therein (preferably, a moisture amount of the ink receiving layer is 0.2 g/m² or less), covering up the periphery of the support (four sides in the case of quadrangle) by laminating with a resin, and storing this by changing the condition from a low humidity condition to a high humidity condition, and obtaining a change in a mass thereupon.

Examples of the method of drying to the extent that moisture does not substantially remain therein include a method of storing in the low humidity atmosphere for a necessary time with or without heating, such as placement in a constant temperature chamber or a dryer of a low humidity atmosphere having a low absolute humidity. Heating may be suitably selected depending on a composition of the ink receiving layer, a drying time and other desire. Specifically, there are a method of performing induction heating by irradiation with microwaves using a microwave generator, and a method of heating with a heating apparatus such as an infrared heater or a heating roller. In each method, for example, heating may be performed by attaching a heating unit (e.g., heating roller) to a roll for supplying a paper of a paper supplying tray of a printer, or attaching a heating unit (e.g., infrared heater or microwave generator) to a tray tip part from which a paper of a paper supplying tray is carried out. In this case, a whole paper supplying tray may be heated. In addition, when double-sided recording is performed, it is preferable to arrange the heating unit (heating part) such as a microwave generator, an infrared heater, or a heating roller at a tray tip part from which a paper of the paper supplying tray is carried out. When double-sided recording is performed, a recording surface is dried after recording on one side of a paper which has been heated and dried by the heating unit, and drying of a moisture contained in an ink is necessary, it is preferable that a fan causing an air stream for exhausting moisture, or a duct part for maintaining an air ejection route is provided. In the case of double-sided recording, after recording on one side of a paper, a back surface to be recorded becomes a recording surface and, after dried again with the heating unit, a back surface is recorded.

The induction heating refers to a heating system in which an object to be heated (herein, for example, an ink image, an ink receiving layer or an inkjet recording medium) is placed in the alternating electric field at a high frequency of a few MHz to several hundred MHz, and a temperature is raised by generation of heat from an object to be heated by the action of a high frequency (electromagnetic wave) to vaporize a liquid component, and the induction heating is performed by using a high frequency induction heating device. The induction heating includes, for example, microwave heating, and high frequency induction heating. The microwave heating refers to generation of heat from the interior of an object to be heated by interaction between microwaves and an object to be heated to vaporize a liquid component and, for example, the microwave heating is performed by using a microwave generator. Specific examples include a microwave drying unit described in Japanese Patent No. 2979393, and a microwave irradiating unit for irradiating microwaves generated in magnetron, described in Japanese Patent No. 3302177

In addition, the infrared heating refers to induction of movement (vibration) of molecules by the energy sympathetic vibration-absorbed by an object to be heated, and generation of heat by the friction to vaporize a liquid component. For the heating device, for example, a halogen lamp, a ceramic far infrared heater, a super-far infrared heater, and an infrared lamp may be used.

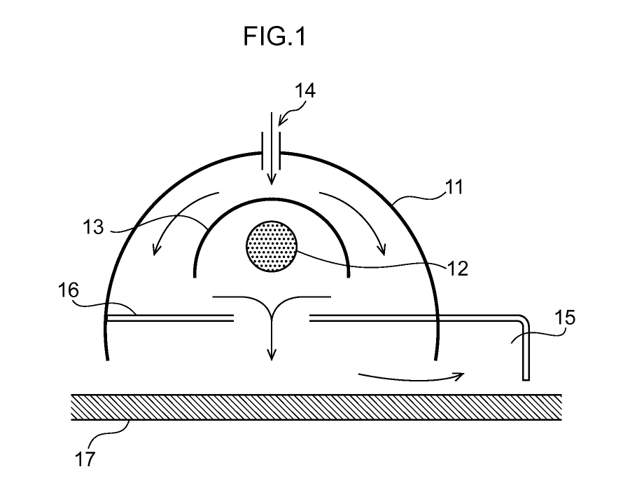

FIG. 1 shows one example of the drying unit of inducing a dry air stream. This drying unit surrounds a heat source (herein, infrared heater) 12 and a heat reflecting plate 13 provided behind the heat source, and is provided with a heating chamber 11, in which a hole-like (slit-like) air stream introducing part 14 is provided, a bulkhead 16 dividing a lower part of the heating chamber, in which an opening part is provided, and a ventilation duct 15. As shown in FIG. 1, the infrared heater 12 is isolated from the inkjet recording medium 17 to be conveyed with the bulkhead so that the inkjet recording medium to be recorded is not burnt, and the surface to be recorded (ink receiving layer) may be dried with radiant heat of the infrared heater and the heated dry air by flowing the heated dry air through the opening part of the bulkhead.

The ink is ejected, for example, within 30 seconds after the ink receiving layer is dried to the extent that moisture does not substantially remain therein, preferably, within 30 seconds under an environment of 23° C. and humidity of 50% RH to 85% RH, thereby, the ink receiving layer having a moisture amount of 1.2 g/m² or less may be recorded. In the inkjet recording method of the invention, an embodiment of ejecting the ink within 10 seconds after drying is preferable in view of obtaining an image stably having good surface state and in which generation of bronzing is more suppressed.

“Ejection within t seconds after drying” is a time (t) from a point of time at which the ink receiving layer is taken out from the drying atmosphere, or a point of time at which the heating device for drying is off, and heating or irradiation with microwaves or the like is completed, until first adhesion of ink droplets to the ink receiving layer.

A maximum total ejection amount of the ink to be ejected at image recording is preferably in a range of 15 g/m² or more, more preferably in a range of 15 g/m² to 30 g/m², even more preferably in a range of 16 g/m² to 25 g/m² in that surface state of the recorded image is good, and the effects of water resistance and preventing occurrence of bronzing are more effectively obtained.

The maximum total ejection amount [g/m²] is the total maximum amount of the ejection amount of each ink per a unit area in the apparatus used, and is calculated from the following equation.

Maximum total ejection amount=maximum ejection amount of one dot [g/m²]×total ink amount [%][total ink amount: total of actual ejection amount (a %) of each ink from out of predetermined ejection amount (A %) of each of color inks [e.g.: Y (yellow), M (magenta), C (cyan) and K (black)].

For example, when the predetermined ejection amount (A %) for each of the four colors YMCK in the apparatus is 100% (the predetermined value for 4 colors is 400% at maximum), for example, when the actual ejection amount (a %) at recording of a gray image is, for example, Y=M=C=K=30%, the ink total amount is 120%, and when the maximum ejection amount for one dot is, for example, 20 g/m², the maximum total ejection amount in this case is 20×1.2=24 g/m².

—Inkjet Recording Medium—

Then, the inkjet recording medium in the invention will be described.

The inkjet recording medium in the invention is constructed such that at least one ink receiving layer is provided on at least one side of the support, and the ink receiving layer may be provided on both sides of the support.

[Ink Receiving Layer]

The ink receiving layer in the invention includes at least an inorganic fine particle, a polyvinyl alcohol-based resin and a water-soluble aluminum compound and, if necessary, the ink receiving layer may further include other components such as a crosslinking agent which crosslinks the polyvinyl alcohol-based resin, a dye mordant, and a surfactant.

—Inorganic Fine Particles—

The ink receiving layer in the invention contains at least one kind of inorganic fine particles.

The inorganic fine particles have a function of enhancing absorption of ink by creating a porous structure when the ink receiving layer is formed.

In cases where the solid matter content of the inorganic fine particles in the ink receiving layer is 50% by mass or more, preferably more than 60% by mass, an inkjet recording medium with sufficient ink absorptivity contributed by a formation of a better porous structure, may be formed. Herein, the expression “solid matter content” of inorganic fine particles in the ink receiving layer refers to the content calculated on the basis of all ingredients except water in the composition for constituting the ink receiving layer.

Examples of inorganic fine particles for use in the invention include silica fine particles, colloidal silica, titanium dioxide, barium sulfate, calcium silicate, zeolite, kolinite, hollysite, mica, talc, calcium carbonate, magnesium carbonate, calcium sulfate, pseudoboehmite, zinc oxide, zinc hydroxide, alumina, aluminum silicate, calcium silicate, magnesium silicate, zirconium oxide, zirconium hydroxide, cerium oxide, lanthanum oxide and yttrium oxide. Among these substances, silica fine particles, colloidal silica, alumina fine particles and pseudoboehmite are preferable over the others from the viewpoint of creating good porous structure.

These inorganic fine particles may be used as they are primary particles, or in a state that they are formed into secondary particles. The average primary particle diameter of these inorganic fine particles is preferably 2 μm or less, and more preferably 200 nm or less.

Moreover, silica fine particles having an average primary particle diameter of 30 nm or less, colloidal silica having an average primary particle diameter of 30 nm or less, alumina fine particles having an average primary particle diameter of 20 nm or less and pseudoboehmite having an average pore radius of from 2 nm to 15 nm are more preferable, and silica fine particles, alumina fine particles and pseudoboehmite are particularly preferable.

Silica fine particles are usually roughly classified into wet method particles and dry method (vapor-phase process) particles in accordance with the method for manufacturing thereof. In the mainstream of the wet method, silica fine particles are mainly produced by generating an activated silica by acid decomposition of a silicate, appropriately polymerizing the activated silica, and aggregation precipitation of the resulting polymeric silica to obtain hydrated silica. On the other hand, in the mainstream of the vapor-phase process, silica (anhydrous silica) particles are produced by either a method having high-temperature vapor-phase hydrolysis of a silicon halide (flame hydrolysis process), or a method having reductively heating and vaporizing quartz sand and coke in an electric furnace, applying an arc discharge and oxidizing the vaporized silica with air (arc method). The “vapor-phase process silica” means a silica (an anhydrous silica fine particle) produced by the vapor-phase process. Vapor-phase process silica fine particles are particularly preferable as the silica fine particles used in the invention.

While the above vapor-phase process silica differs from hydrated silica in terms of the density of silanol groups on its surfaces, the presence or absence of voids therein, and the like, and exhibits different properties from hydrated silica, vapor-phase process silica is suitable for forming a three-dimensional structure which has a high porosity. While the reason for this is not clearly understood, it can be supposed as follows. Namely, hydrated silica fine particles have a high density of silanol groups on the surface, at from 5 per nm² to 8 per nm², thus the silica fine particles tend to coagulate (aggregate) densely. In contrast, vapor-phase process silica particles have a lower density of silanol groups on the surface, at from 2 per nm² to 3 per nm², thus vapor-phase process silica seems to form less compact, loose coagulations (flocculations), consequently leading to a structure with a higher porosity.

The vapor-phase process silica has a particularly large specific surface, high ink absorptivity and retention efficiency, and a low refractive index. Therefore, the vapor-phase process silica has features such that it can impart transparency to the receiving layer and ensure high color densities and good coloring property when dispersion thereof is performed until it comes to have appropriate particle diameters. It is important for the receiving layer to be transparent from the viewpoint of delivering high color densities and good coloring gloss in not only transparency-required uses, such as OHP, but also applications to recording media, such as gloss photo paper.

An average primary particle diameter of the vapor-phase process silica particles is preferably 30 nm or less, more preferably 20 nm or less, particularly preferably 10 nm or less, and most preferably in a range of from 3 nm to 10 nm. Since the vapor-phase process silica particles easily adhere to each other by hydrogen bonds due to the silanol groups, a structure having a high porosity can be formed thereby when the average primary particle diameter is 30 nm or less, whereby the ink absorption characteristic can be effectively improved.

The silica fine particles may be used in combination with other fine particles described above. When the other fine particles are used in combination with the vapor-phase process silica, the amount of the vapor-phase process silica with respect to the total amount of fine particles is preferably 30% by mass or higher, and more preferably 50% by mass or higher.

Preferable examples of inorganic fine particles which can be additionally used in the invention include alumina fine particles, alumina hydrate, mixtures thereof and composites thereof. Among them, alumina hydrate is further preferable, as it absorbs and holds inks well. Pseudo-boemite (Al₂O₃:nH₂O) is particularly preferable. Alumina hydrate may be used in a variety of forms. Alumina hydrate is preferably prepared by using boehmite in the sol state as the starting material, as it easily provides smoother layers.

An average pore radius of pseudo-boemite is preferably in a range of from 1 nm to 30 nm and more preferably in a range of from 2 nm to 15 nm. The pore volume thereof is preferably in a range of from 0.3 mL/g to 2.0 mL/g, and more preferably in a range of from 0.5 mL/g to 1.5 mL/g. The average pore radius and the pore volume are determined by a nitrogen absorption-desorption method. These values may be determined, for example, by using a gas absorption-desorption analyzer (e.g., trade name: OMNISORP 369, manufactured by Beckman Coulter, Inc.).

Among the alumina fine particles, vapor-phase process alumina fine particles are preferable because of a large specific surface thereof. The average primary particle diameter of the vapor-phase process alumina is preferably 30 nm or less, and more preferably 20 nm or less.

In application of the inorganic fine particles to an inkjet recording medium, each of the embodiments disclosed in JP-A Nos. 10-81064, 10-119423, 10-157277, 10-217601 and 11-348409, JP-A Nos. 2001-138621, 2000-43401, 2000-211235, 2000-309157, 2001-96897 and 2001-138627, JP-A Nos. 11-91242, 8-2087, 8-2090, 8-2091, 8-2093, 8-174992 and 11-192777, and JP-A No. 2001-301314 can be utilized as one embodiment of the present invention.

—Polyvinyl Alcohol-Based Resin—

The ink receiving layer in the invention contains at least one kind of polyvinyl alcohol-based resin. The polyvinyl alcohol-based resins are resins having a hydroxy group as a hydrophilic structural unit, and examples of the polyvinyl alcohol-based resins include polyvinyl alcohol (PVA), acetoacetyl-modified polyvinyl alcohols, cation-modified polyvinyl alcohols, anion-modified polyvinyl alcohols, silanol-modified polyvinyl alcohols, polyvinylacetal and the like.

Examples of the polyvinyl alcohol-based resins include the substances described in Japanese Patent Application Publication (JP-B) Nos. 4-52786, 5-67432 and 7-29479, Japanese Patent No. 2537827, JP-B No. 7-57553, Japanese Patent Nos. 2502998 and 3053231, JP-A No. 63-176173, Japanese Patent No. 2604367, JP-A Nos. 7-276787, 9-207425, 11-58941, 2000-135858, 2001-205924, 2001-287444, 62-278080 and 9-39373, Japanese Patent No. 2750433, JP-A Nos. 2000-158801, 2001-213045, 2001-328345, 8-324105, 11-348417, 58-181687, 10-259213, 2001-72711, 2002-103805, 2000-63427, 2002-308928, 2001-205919 and 2002-264489.

—Content Ratio of Inorganic Fine Particle and Polyvinyl Alcohol-Based Resin—

In the invention, a content ratio of the inorganic fine particle (P) to the polyvinyl alcohol-based resin (B) (P/B [mass ratio]; PB ratio) is in a range of 3 to 5. When the PB ratio is less than 3, an amount of the polyvinyl alcohol-based resin is too much relative to an amount of the inorganic fine particle, voids are easily clogged with the resin, decrease in a void rate reduces ink absorptivity and, at the same time, the film becomes hygroscopic, and bronzing property of an image is deteriorated. Conversely, when the PB ratio is more than 5, an amount of the polyvinyl alcohol-based resin is too small relative to an amount of the inorganic fine particle, a film strength becomes weak, cracking is easily caused in the ink receiving layer, and the good surface state may be not retained. On the other hand, when the PB ratio is 3 or more, a high speed and good ink absorptivity may be maintained and, when the PB ratio is 5 or less, a film strength may be retained.

Inter alia, the PB ratio is preferably in a range of 3.0 to 4.5, and more preferably in a range of 3.5 to 4.5.

For example, by coating a coating solution including a dispersion obtained by dispersing a vapor-phase process silica fine particle having an average primary particle diameter of 20 nm or less, and the polyvinyl alcohol-based resin in an aqueous solution at the above PB ratio, on a support, and drying this, a three-dimensional network structure having network chains of secondary particles of silica fine particles is obtained, and a light-transmitting porous layer having an average pore diameter of 30 nm or less, a void rate of 50% to 80%, a pore specific volume of 0.5 mL/g or more, and a specific surface area of 100 m²/g or more, may be formed.

Other water-soluble resins other than the polyvinyl alcohol-based resin may be used together in such the range that the effect of the invention is not deteriorated. Examples of the other water-soluble resin include cellulose-based resin [methyl cellulose (MC), ethyl cellulose (EC), hydroxyethyl cellulose (HEC), carboxymethyl cellulose (CMC), hydroxypropyl celluloce (HPC), hydroxyethyl methyl cellulose, hydroxypropyl methyl cellulose etc.], chitins, chitosans, starch, a resin having an ether bond [polyethylene oxide (PEO), polypropylene oxide (PPO), polyethylene glycol (PEG), polyvinyl ether (PVE) etc.], a resin having a carbamoyl group [polyacrylamide (PAAM), polyvinyl pyrrolidone (PVP), polyacryl hydrazide etc.]. Further examples include water-soluble resins having a carboxy group as a dissociative group, such as a salt of polyacrylic acid, a maleic acid resin, a salt of arginic acid, and gelatins. Examples of the other water-soluble resin include compounds described in paragraph numbers [0011] to [0012] of JP-A No. 11-165461, and compounds described in JP-A Nos. 2001-205919 and 2002-264489.

The water-soluble resin and the inorganic fine particle mainly contained in the ink receiving layer may be a single material, respectively, or a mixed system of a plurality of materials may be used.

The water-soluble resin may be used alone, or two or more of them may be used together. When other water-soluble resin is used together, a content of the other water-soluble resin in the ink receiving layer is preferably 50% by mass or less with respect to the polyvinyl alcohol-based resin.

From the viewpoint of retention of transparency, a combination of an inorganic fine particle, particularly a silica fine particle (inter alia, vapor-phase process silica), and the polyvinyl alcohol-based resin is preferable and, inter alia, a combination of a vapor-phase process silica and a polyvinyl alcohol-based resin having a saponification degree of 70% to 100% is more preferable, and a combination of a vapor-phase process silica and a polyvinyl alcohol-based resin having a saponification degree of 80% to 99.5% is particularly preferable.

The polyvinyl alcohol-based resin has a hydroxy group in its structural unit, and since this hydroxy group and a surface silanol group of the silica fine particle form a hydrogen bond, a three-dimensional network structure having a network chain unit of secondary particles of the silica fine particles is easily formed. It is thought that, by formation of this three-dimensional network structure, the ink receiving layer of a porous structure having a high void rate and a high strength is formed. In inkjet recording, the ink receiving layer of a porous structure absorbs rapidly an ink by capillary phenomenon, and dots having high circularity may be formed without generating ink blur.

—Water-Soluble Aluminum Compound—

The ink receiving layer in the invention contains at least one water-soluble aluminum compound. By inclusion of the water-soluble aluminum compound, ozone resistance, blur resistance and water resistance of the image may be improved. On the other hand, the water-soluble aluminum compound has a defect that it easily generates bronzing.

The water-soluble aluminum compounds as inorganic salts include, for example, aluminum chloride or hydrates thereof, aluminum sulfate or hydrates thereof, and aluminum alum, basic polyaluminum hydroxide compounds as inorganic aluminum-containing cationic polymers (hereafter sometimes referred to as basic polyaluminum chloride or polyaluminum chloride).

The term “basic polyaluminum hydroxide compounds” described above refers to the water-soluble polyaluminum hydroxides whose main components are represented by the following formula 1, 2 or 3, and wherein a basic polymeric polynuclear condensed ions, such as [Al₆(OH)₁₅]³⁺, [Al₈(OH)₂₀]⁴⁺, [Al₁₃(OH)₃₄]⁵⁺ or [Al₂₁(OH)₆₀]³⁺, are contained with stability.

Formula 1: [Al₂(OH)ₙCl₆₋ₙ]ₘ

Formula 2: [Al(OH)₃]ₙAlCl₃

Formula 3: Alₙ(OH)ₘCl₍₃ₙ₋ₘ₎, 0<m<3n

Such basic polyaluminum hydroxide compounds are available from TAKI CHEMICAL CO., LTD. as a water treatment chemical under the trade name of Polyaluminum Chloride (PAC), Asada Chemical Industry Co., Ltd. under the trade name of Polyaluminum Hydroxide (Paho), rikengreen Co., Ltd. under the trade name of HAP-25, TAIMEI Chemicals Co., Ltd. under the trade name of ALFINE 83, or other makers as products developed with intentions similar to the above, and their products in various grades may be used.

A coating amount of the water-soluble aluminum compound in the ink receiving layer is preferably 0.2 g/m² to 3 g/m², and more preferably 0.5 g/m² to 2 g/m². When the content of the water-soluble aluminum compound is 0.2 g/m² or more, water resistance of the image is good and, when the content is 3 g/m² or less, this is advantageous in respect of surface state, and a high color density after recording.

—Crosslinking Agent—

The ink receiving layer in the invention may be constructed using at least one crosslinking agent which crosslinks the polyvinyl alcohol-based resin, and occasionally, other water-soluble resin. The ink receiving layer is preferably an embodiment of a porous layer cured by a crosslinking reaction between the crosslinking agent and the water-soluble resin such as a polyvinyl alcohol-based resin.

For crosslinking of the water-soluble resins, notably polyvinyl alcohol-based resin, boron compounds are suitably used.

Examples of such boron compounds include borax, boric acid, borates (such as orthoborate, InBO₃, ScBO₃, YBO₃, LaBO₃, Mg₃(BO₃)₂ and CO₃(BO₃)₂), diborates (such as Mg₂B₂O₅ and CO₂B₂O₅), metaborates (such as LiBO₂, Ca(BO₂)₂, NaBO₂ and KBO₂), tetraborates (such as Na₂B₄O₇.10H₂O), pentaborates (such as KB₅O₈.4H₂O and CsB₅O₅) and hexaborates (such as Ca₂B₆O₁₁.7H₂O). Of these boron compounds, borax, boric acid and borates, especially boric acid, are used to advantage in point of quick induction of crosslinking reaction.

As crosslinking agents for the water-soluble resins, compounds other than the boron compounds can also be used.

The other compounds include, for example, aldehyde compounds, such as formaldehyde, glyoxal and gurtaraldehyde; ketone compounds, such as diacetyl and cyclopentanedione; active halogen compounds, such as bis(2-chloroethylurea), 2-hydroxy-4,6-dichloro-1,3,5-triazine and sodium 2,4-dichloro-6-hydroxy-s-triazine); active vinyl compounds, such as divinylsulfonic acid, 1,3-bis(vinylsulfonyl)-2-propanol, N,N′-ethylenebis(vinylsulfonylacetamido) and 1,3,5-triacryloyl-hexahydro-s-triazine; N-methylol compounds, such as dimethylolurea and methyloldimethylhydantoin; melamine resins, such as methylolmelamine and alkylated methylolmelamine; epoxy resins; isocyanate compounds, such as 1,6-hexamethylene diisocyanate; aziridine compounds disclosed in U.S. Pat. Nos. 3,017,280 and 2,983,611; carboxylmide compounds described in U.S. Pat. No. 3,100,704; epoxy compounds, such as glycerol triglycidyl ether; ethyleneimino compounds, such as 1,6-hexamethylene-N,N′-bisethyleneurea; halogenated carboxyaldehyde compounds, such as mucochloric acid and mucophenoxychloric acid; dioxane compounds, such as 2,3-dihydroxydioxane; metal-containing compounds, such as titanium lactate, aluminum sulfate, chrome alum, potassium alum, zirconyl acetate and chromium acetate; polyamine compounds, such as tetraethylenepentamine; hydrazide compounds, such as adipic dihydrazide; and low-molecular compounds and polymers each having at least two oxazoline groups.

The crosslinking agents can be used alone or in a combination of any two or more of them. The amount of crosslinking agent(s) used is preferably from 1% by mass to 50% by mass, more preferably from 5% by mass to 40% by mass, with respect to a total amount of the polyvinyl alcohol-based resin and the other water-soluble resin.

—Nitrogen-Containing Organic Cationic Polymer—

From the viewpoint of suppression of blur of a recorded image and from the viewpoint of dispersibility of silica, it is preferable that the ink receiving layer in the invention is constructed using at least one nitrogen-containing organic cationic polymer.

The nitrogen-containing organic cationic polymer is not particularly limited, but a polymer having a primary to tertiary amino group or a quaternary ammonium salt group is suitable.

As the nitrogen-containing organic cationic polymer, a homopolymer of a monomer having a primary to tertiary amino group or a group derived from a salt thereof or a quaternary ammonium salt group (nitrogen-containing organic cationic monomer), and a copolymer or a polycondensate of the nitrogen-containing organic cationic monomer and other monomer are preferable.

The nitrogen-containing organic cationic polymer may be any form of a water-soluble polymer or a water-dispersible latex particle.

Examples of the nitrogen-containing organic cationic monomer include trimethyl-p-vinylbenzylammonium chloride, trimethyl-m-vinylbenzylammonium chloride, triethyl-p-vinylbenzylammonium chloride, triethyl-m-vinylbenzylammonium chloride, N,N-dimethyl-N-ethyl-N-p-vinylbenzylammonium chloride, N,N-diethyl-N-methyl-N-p-vinylbenzylammonium chloride, N,N-dimethyl-N-n-propyl-N-p-vinylbenzylammonium chloride, N,N-dimethyl-N-n-octyl-N-p-vinylbenzylammonium chloride, N,N-dimethyl-N-benzyl-N-p-vinylbenzylammonium chloride, N,N-diethyl-N-benzyl-N-p-vinylbenzylammonium chloride, N,N-dimethyl-N-(4-methyl)benzyl-N-p-vinylbenzylammonium chloride, N,N-dimethyl-N-phenyl-N-p-vinylbenzylammonium chloride, trimethyl-p-vinylbenzylammonium bromide, trimethyl-m-vinylbenzylammonium bromide, trimethyl-p-vinylbenzylammonium sulfonate, trimethyl-m-vinylbenzylammonium sulfonate, trimethyl-p-vinylbenzylammonium acetate, trimethyl-m-vinylbenzylammonium acetate, N,N,N-triethyl-N-2-(4-vinylphenyl)ethylammonium chloride, N,N,N-triethyl-N-2-(3-vinylphenyl)ethylammonium chloride, N,N-diethyl-N-methyl-N-2-(4-vinylphenyl)ethylammonium chloride, N,N-diethyl-N-methyl-N-2-(4-vinylphenyl)ethylammonium acetate, quaternarized products prepared by reacting N,N-dimethylaminoethyl (meth)acrylate, N,N-diethylaminoethyl (meth)acrylate, N,N-dimethylaminopropyl (meth)acrylate, N,N-diethylaminopropyl (meth)acrylate, N,N-dimethylaminoethyl (meth)acrylamide, N,N-diethylaminoethyl (meth)acrylamide, N,N-dimethylaminopropyl (meth)acrylamide or N,N-diethylaminopropyl (meth)acrylamide with methyl chloride, ethyl chloride, methyl bromide, ethyl bromide, methyl iodide or ethyl iodide, and sulfonates, alkylsulfonates, acetates or alkylcarboxylates obtained by anion substitution of these quaternarized products.

Examples of such products include monomethyldiallylammonium chloride, trimethyl-2-(methacryloyloxy)ethylammonium chloride, triethyl-2-(methacryloyloxy)ethylammonium chloride, trimethyl-2-(acryloyloxy)ethylammonium chloride, triethyl-2-(acryloyloxy)ethylammonium chloride, trimethyl-3-(methacryloyloxy)propylammonium chloride, triethyl-3-(methacryloyloxy)propylammonium chloride, trimethyl-2-(methacryloylamino)ethylammonium chloride, triethyl-2-(methacryloylamino)ethylammonium chloride, trimethyl-2-(acryloylamino)ethylammonium chloride, triethyl-2-(acryloylamino)ethylammonium chloride, trimethyl-3-(methacryloylamino)propylammonium chloride, triethyl-3-(methacryloylamino)propylammonium chloride, triethyl-3-(acryloylamino)propylammonium chloride, triethyl-3-(acryloylamino)propylammonium chloride, N,N-dimethyl-N-ethyl-2-(methacryloyloxy)ethylammonium chloride, N,N-diethyl-N-methyl-2-(methacryloyloxy)ethylammonium chloride, N,N-dimethyl-N-ethyl-3-(acryloylamino)propylammonium chloride, trimethyl-2-(methacryloyloxy)ethylammonium bromide, trimethyl-3-(acryloylamino)propylammonium bromide, trimethyl-2-(methacryloyloxy)ethylammonium sulfonate and trimethyl-3-(acryloylamino)propylammonium acetate. In addition to the monomers described above, N-vinylimidazole and N-vinyl-2-methylimidazole can be used as monomers copolymerizable with these monomers. Moreover, it is possible to utilize polymers having vinylamine units obtained from their original polymerizing units, such as N-vinylacetamide and N-vinylformamide, by hydrolysis after polymerization, and the polymers having salt-form units converted from these vinylamine units.

As the other monomers copolymerizable (polycondensatable) with the organic nitrogen-containing cationic monomers as recited above, monomers having neither a basic nor cationic moiety, such as a primary, secondary or tertiary amino group, a salt thereof, or a quaternary ammonium salt group, and showing no or substantially weak interaction with dyes in ink can be used. Examples of such comonomers include alkyl esters of (meth)acrylic acid; cycloalkyl esters of (meth)acrylic acid, such as cyclohexyl (meth)acrylate; aryl esters of (meth)acrylic acid, such as phenyl (meth)acrylate; aralkyl esters, such as benzyl (meth)acrylate; aromatic vinyl compounds, such as styrene, vinyltoluene and α-methylstyrene; vinyl esters, such as vinyl acetate, vinyl propionate and vinyl versatates; allyl esters, such as allyl acetate; halogen-containing monomers, such as vinylidene chloride and vinyl chloride; vinyl cyanides, such as (meth)acrylonitrile; and olefins, such as ethylene and propylene.

The alkyl esters of (meth)acrylic acid are preferably those containing 1 to 18 carbon atoms in their respective alkyl moieties, with examples including methyl (meth)acrylate, ethyl (meth)acrylate, propyl (meth)acrylate, isopropyl (meth)acrylate, n-butyl (meth)acrylate, isobutyl (meth)acrylate, t-butyl (meth)acrylate, hexyl (meth)acrylate, octyl (meth)acrylate, 2-ethylhexyl (meth)acrylate, lauryl (meth)acrylate and stearyl (meth)acrylate. Among these (meth)acrylates, methyl acrylate, ethyl acrylate, methyl methacrylate, ethyl methacrylate and hydroxyethyl methacrylate are preferable. The other monomers can be used alone or in a combination of two or more of them.

Among the organic nitrogen-containing cationic polymers recited above, cationic polyurethanes and the cationic polymers described in JP-A No. 2004-167784 are preferable over the others from the viewpoint of suppression of blur, and cationic polyurethanes are more preferable.

Examples of commercially available products of cationic polyurethanes include SUPERFLEX 650, F-8564D and F-8570D (trade names; all manufactured by DAI-ICHI KOGYO SEIYAKU CO., LTD.), and NEOFIX IJ-150 (trade name; manufactured by NICCA CHEMICAL CO., LTD.).

From the viewpoint of dispersibility of silica, poly(diallyldimethylammonium chloride) and derivatives of poly(methacryloyloxyethyl-β-hydroxyethyldimethylammonium chloride) are preferable, and poly(diallyldimethylammonium chloride) is preferable by far.

One example of commercially available products of such polymers is CHEMISTAT 7005 (trade name; manufactured by Sanyo Chemical Industries, Ltd.).

In addition, as the nitrogen-containing organic cationic polymer, a polymer obtained from a cationic emulsion is also suitable. As used herein, the “cationic emulsion” refers to a cationic or cationization-modified aqueous emulsion. Specific examples include an emulsion obtained by cationizing the following emulsion using a cationic group: an emulsion of conjugated diene-based copolymer such as styrene-butadiene copolymer, or methyl methacrylate-butadiene copolymer; an emulsion of acryl-based polymer such as a polymer of acrylic acid ester or methacrylic acid ester, or a copolymer thereof, a polymer of acrylic acid or methacrylic acid or a copolymer thereof; an emulsion of styrene-acryl-based polymer such as styrene-acrylic acid ester copolymer, or styrene-methacrylic acid ester copolymer; an emulsion of vinyl-based polymer such as ethylene vinyl acetate copolymer; or a urethane-based emulsion having a urethane bond, as well as an emulsion having a surface cationized with a cationic surfactant, and an emulsion obtained by polymerization in the presence of cationic polyvinyl alcohol, and having the polyvinyl alcohol distributed over an emulsion surface. Among these cationic emulsions, a cationic emulsion having a main component of a urethane-based emulsion is preferable.

In the ink receiving layer, in order to improve water resistance and image blur resistance over time, other dye mordant other than the nitrogen-containing organic cationic polymer may be used.

Examples of the other dye mordant include a polymer dye mordant having a primary to tertiary amino group or a quaternary ammonium base as a cationic functional group, an organic dye mordant such as a cationic non-polymer dye mordant, and an inorganic dye mordant such as a water-soluble metal compound. Examples of the water-soluble metal compound include water-soluble polyvalent metal compounds, and a compound of a metal having a valency of 3 or more is preferable. Further examples of the inorganic dye mordant include water-soluble salts of a metal selected from calcium, barium, manganese, copper, cobalt, nickel, aluminum, iron, zinc, zirconium, chromium, tungsten, and molybdenum.

—Other Ingredients—

The ink receiving layer in the invention may further contain other ingredients including dye mordants other than the above, various types of surfactants and the like in accordance with necessity.

As the other ingredients, those chosen appropriately from the ingredients described in JP-A No. 2005-14593, paragraphs [0088] to [0117], and JP-A No. 2006-321176, paragraphs [0138] to [0155], can be used.

<Support>

The inkjet recording medium in the invention comprises a support. As the support, both a transparent support made from a transparent material such as plastic and an opaque support made from an opaque material such as paper can be used. In order to exploit the transparency of the ink-receiving layer, the use of a transparent support or a high-gloss opaque support is advantageous. Alternatively, it is possible to use as the support a read-only optical disc, such as CD-ROM or DVD-ROM, a write-once optical disc, such as CD-R or DVD-R, or a rewritable optical disc, and provide the ink-receiving layer on the label face of such a disc.

A transparent material resistant to radiant heat applied thereto when the medium is used on an OHP or back light display is preferable as the material for the transparent support. Examples of the material include polyesters such as polyethylene terephthalate (PET), polysulfone, polyphenylene oxide, polyimide, polycarbonate, polyamide and the like. Among them, polyesters are preferable, and polyethylene terephthalate is particularly preferable. The thickness of the transparent support has no particular limitation, but it is preferably from 50 μm to 200 μm in point of easy handling.

The high-gloss opaque support preferably has a glossiness of 40% or more on the surface where the ink receiving layer is formed. The glossiness is a value determined by a known method taught by JIS P-8142, i.e., Paper and board—Measurement of specular gloss—Part 1: 75 degree gloss with a converging beam. Specific examples of the supports include the following.

Specific examples of the high-gloss opaque support include: high-gloss paper supports such as art paper, coated paper, cast-coated paper, and baryta-coated paper commonly used as a support for use in silver salt photographic material and the like; high-gloss films opacified by adding a white pigment or the like to any one of plastic films such as polyesters such as polyethylene terephthalate (PET), nitrocellulose, cellulose esters such as cellulose acetate, cellulose acetate butyrate, polysulfone, polyphenylene oxide, polyimide, polycarbonate, polyamide or the like (which may be additionally surface calendered); supports having a polyolefin coated layer containing or not containing a white pigment formed on the surface of these various paper, the transparent supports, or the high-gloss films containing a white pigment; or the like.

Foamed polyester films containing a white pigment (e.g., a foamed polyester formed by expanding a polyolefin fine particle-containing PET film so as to forming voids therein) are favorable and also included as examples. In addition, resin coated papers commonly used as photographic papers for silver salt photographs are also preferable.

While the thickness of the opaque support is not particularly limited, it is preferably in a range of 50 μm to 300 μm from the viewpoint of ease of handling.

The surface of support may be subjected to corona discharge treatment, glow discharge treatment, flame treatment, ultraviolet ray irradiation treatment or the like for improvement in wetting property and adhesive property.

Then, base paper used in the resin coated papers is described in detail.

The base paper is made from wood pulp as a principal material and, if needed, synthetic pulp made from, e.g., polypropylene, or synthetic fiber, such as nylon fiber or polyester fiber, as an additional material. As the wood pulp, any of LBKP, LBSP, NBKP, NBSP, LDP, NDP, LUKP and NUKP can be used. It is preferable to use wood pulp with a high content of short fibers, such as LBKP, NBSP, LBSP, NDP or LDP.

However, the proportion of LBSP and/or LDP is preferably from 10% by mass to 70% by mass.

Chemical pulps (such as sulfate salt pulp or sulfurous acid pulp) containing a smaller amount of impurities are preferably used as the pulp used in the invention. Bleached pulps which are improved in whiteness are also useful.

Various additives including a sizing agent such as higher fatty acid or alkyl ketene dimer, a white pigment such as calcium carbonate, talc or titanium oxide, a paper-strength enhancing additive such as starch, polyacrylamide or polyvinyl alcohol, a fluorescent whitening agent, a moisturizing agent such as polyethylene glycols, a dispersing agent, a softener such as quaternary ammonium, and the like may be added to the base paper in accordance with necessity.

The freeness of the pulp for use in sheeting is preferably 200 mL to 500 mL as per CSF (Canadian Standard Freeness) regulations. In regard to the fiber length after beating, the total amount of pulps remaining on 24- and 42-mesh screens is preferably 30% by mass to 70% by mass, as determined by the known method taught by JIS P-8207, i.e., Paper and board—Determination of thickness and density. Further, the amount of the pulp remaining on 4-mesh screen is preferably 20% by mass or less.

The basis weight of base paper is preferably from 30 g/m² to 250 g/m², and particularly preferably from 50 g/m² to 200 g/m². The thickness of base paper is preferably from 40 μm to 250 μm. It is also possible to impart high smoothness to base paper by performing calender treatment during a papermaking stage or after the papermaking has finished. The base paper density is generally from 0.7 g/cm³ to 1.2 g/cm³ (JIS P-8118).

Furthermore, the stiffness of base paper is preferably from 20 g to 200 g under conditions defined by JIS P-8143.

The base paper surface may be coated with a surface sizing agent, and a similar sizing agent as added for internal sizing of base paper can also be used as the surface sizing agent.

The pH of base paper is preferably from 5 to 9 as measured according to the hydrothermal extraction method defined by JIS P-8113.

In a case where the front and rear surfaces of the base paper as a support is covered with a polyethylene, the polyethylene covering the base paper is mainly a low-density polyethylene (LDPE) and/or a high-density polyethylene (HDPE), but other LLDPE, polypropylene, or the like may also be used partially.

In particular, the polyethylene layer at the side on which the ink-receiving layer is provided is preferably formed of polyethylenes containing rutile-titanium oxide, anatase-titanium oxide, a fluorescent whitening agent, and/or ultramarine that are improved in opacity, whiteness and hue, which are commonly used in photographic papers. The content of the titanium oxide is preferably in a range of from about 3% by mass to about 20% by mass, and more preferably in a range of from 4% by mass to 13% by mass, with respect to the polyethylene. The thickness of the polyethylene layer, either front or rear, is not particularly limited, but is favorably in a range of from 10 μm to 50 μm. In addition, an undercoat layer may be formed on the polyethylene layer for increasing the adhesive property thereof to an ink-receiving layer. Water-based polyester, gelatin, and PVA are preferable for the undercoat layer. The thickness of the undercoat layer is preferably in a range of from 0.01 μm to 5 μm.

The polyethylene covered paper may be used as a glossy paper.

The polyethylene layer coated on the surface of the base paper by melt-extrusion may be further subjected to a surface modification treatment such as embossing so that it has a matte or silky surface similar to that of common photographic printing papers.

The support can be provided with a backcoat layer. Components composing the backcoat layer include a white pigment, a water-based binder or other ingredients.

Examples of the white pigment which can be incorporated into the backcoat layer include inorganic white pigments, such as precipitated calcium carbonate, ground calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudoboehmite, aluminum hydroxide, alumina, lithopone, zeolite, hydrous halloysite, magnesium carbonate and magnesium hydroxide; and organic pigments, such as styrene-based plastic pigment, acrylic plastic pigment, polyethylene, microcapsules, urea resin and melamine resin.

Examples of the aqueous binders for use in the backcoat layer include water-soluble polymers such as copolymers of styrene/maleic acid salt, copolymers of styrene/acrylic acid salt, polyvinyl alcohol, silanol-modified polyvinyl alcohols, starch, cationic starch, casein, gelatin, carboxymethyl cellulose, hydroxyethyl cellulose, or polyvinyl pyrrolidone; water-dispersible polymers such as styrene butadiene latexes or acryl emulsions; and the like.

The other components contained in the backcoat layer include a defoaming agent, antifoaming agent, dye, fluorescent whitening agent, antiseptic, water-resistance imparting agent, and the like.

[Others]

The inkjet recording medium in the invention may further have an ink solvent absorbing layer, an intermediate layer, and a protective layer in addition to the ink receiving layer. Alternatively, on the support, an undercoat layer may be provided for the purpose of enhancing adhesion between the ink receiving layer and the support, and suitably adjusting an electric resistance value.

—Ink—

Then, an ink used in inkjet recording will be described.

As the ink, any of a pigment ink containing a pigment as a colorant, and a dye ink containing a dye as a colorant may be used, and the dye ink is preferable in that the effects of the invention, that is, the effect of improving water resistance of the image and prevention of bronzing are large. In the invention, low water resistance and bronzing in the image using a dye (particularly cyan dye) are more effectively prevented.

The ink may be a black ink, or a color ink such as a yellow, magenta or cyan ink. Furthermore, glycol ether may be added to the ink, whereby the property of the ink to penetrate to the recording medium is improved and an image in which image blurring is suppressed may be expected.

The dye is not specifically limited, and examples may include water-soluble acidic dyes, direct dyes, basic dyes and reactive dyes described in the COLOR INDEX. Furthermore, exemplary embodiments using the water-soluble dye represented by the following Formula (C-1) is preferable, from the viewpoint of exhibiting effects for keeping water resistance of the image recorded on the ink receiving layer, and for suppressing bronzing to occur. In this regard, the water-soluble dye refers to a dye that dissolves by 1% by mass or more in water at 20° C.

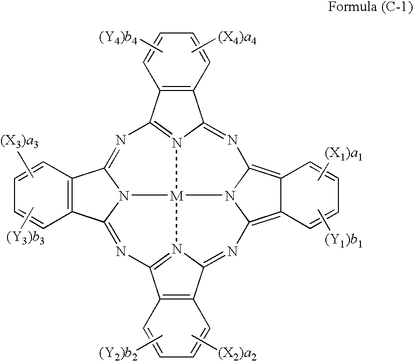

In Formula (C-1), each of X₁, X₂, X₃ and X₄ independently represents any of —SO—Z, —SO₂—Z, —SO₂NV₁V₂, —CONV₁V₂, —CO₂Z, —CO—Z, or a sulfo group.

Z each independently represents a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group.

Z preferably represents a substituted or unsubstituted alkyl group, a substituted or unsubstituted aryl group, or a substituted or unsubstituted heterocyclic group, more preferably a substituted alkyl group, a substituted aryl group, or a substituted heterocyclic group, and particularly preferably a substituted alkyl group.

V₁ and V₂, which may be the same or different, each represent a hydrogen atom, a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group. Each of V₁ and V₂ preferably represents, independently, a hydrogen atom, a substituted or unsubstituted alkyl group, a substituted or unsubstituted aryl group, or a substituted or unsubstituted heterocyclic group, and most preferably a hydrogen atom, a substituted alkyl group, a substituted aryl group, or a substituted heterocyclic group.

Each of Y₁, Y₂, Y₃ and Y₄ independently represents a hydrogen atom, a halogen atom, an alkyl group, a cycloalkyl group, an akenyl group, an aralkyl group, an aryl group, a heterocyclic group, a cyano group, a hydroxy group, a nitro group, an amino group, an alkylamino group, an alkoxy group, an aryloxy group, an amido group, an arylamino group, a ureido group, a sulfamoylamino group, an alkylthio group, an arylthio group, an alkoxycarbonylamino group, a sulfonamido group, a carbamoyl group, a sulfamoyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imido group, a heterocyclic thio group, a phosphoryl group, an acyl group, or an ionic hydrophilic group. Each group of them may further have a substituent.

a₁ to a₄ and b₁ to b₄ respectively represent numbers of X₁ to X₄ and Y₁ to Y₄. Each of a₁ to a₄ independently represents an integer of from 0 to 4, provided that all of a₁ to a₄ do not represent 0 at the same time, and each of b₁ to b₄ independently represents an integer of from 0 to 4.

M represents a hydrogen atom, a metal atom or an oxide thereof, a hydroxide thereof, or a halide thereof. At least one of X₁, X₂, X₃, X₄, Y₁, Y₂, Y₃ or Y₄ represents an ionic hydrophilic group, or a group having an ionic hydrophilic group as a substituent.

In Formula (C-1) in the invention, it is preferable that a₁, a₂, a₃, and a₄ are each independently 0 or 1; two or more of a₁, a₂, a₃, and a₄ are 1; and b₁, b₂, b₃, and b₄ are each independently an integer which satisfy the equation of a₁+b₁=4, a₂+b₂=4, a₃+b₃=4, and a₄+b₄=4, respectively.

Z, V₁ and V₂ may further have a substituent. As the substituents that Z, V₁ and V₂ may have independently, a halogen atom (e.g., a chlorine atom, a bromine atom), a straight chain or branched alkyl group having from 1 to 12 carbon atoms, an aralkyl group having from 7 to 18 carbon atoms, an alkenyl group having from 2 to 12 carbon atoms, a straight chain or branched alkynyl group having from 2 to 12 carbon atoms, a cycloalkyl group having from 3 to 12 carbon atoms that may have a side chain, a cycloalkenyl group having from 3 to 12 carbon atoms that may have a side chain (as these groups, e.g., methyl, ethyl, propyl, isopropyl, t-butyl, 2-methanesulfonylethyl, 3-phenoxypropyl, trifluoromethyl, and cyclopentyl are described); an aryl group (e.g., phenyl, 4-t-butylphenyl, 2,4-di-t-amylphenyl); a heterocyclic group (e.g., imidazolyl, pyrazolyl, triazolyl, 2-furyl, 2-thienyl, 2-pyrimidinyl, 2-benzothiazolyl); an alkyloxy group (e.g., methoxy, ethoxy, 2-methoxyethoxy, 2-methanesulfonylethoxy); an aryloxy group (e.g., phenoxy, 2-methylphenoxy, 4-t-butylphenoxy, 3-nitrophenoxy, 3-t-butyloxycarbamoylphenoxy, 3-methoxycarbamoyl); an acylamino group (e.g., acetamido, benzamido, 4-(3-t-butyl-4-hydroxyphenoxy)butanamido); an alkylamino group (e.g., methylamino, butylamino, diethylamino, methylbutylamino); an anilino group (e.g., phenylamino, 2-chloroanilino); a ureido group (e.g., phenylureido, methylureido, N,N-dibutylureido); a sulfamoylamino group (e.g., N,N-dipropylsulfamoylamino); an alkylthio group (e.g., methylthio, octylthio, 2-phenoxyethylthio); an arylthio group (e.g., phenylthio, 2-butoxy-5-t-octylphenylthio, 2-carboxyphenylthio); an alkyloxycarbonylamino group (e.g., methoxycarbonylamino); a sulfonamido group (e.g., methanesulfonamido, benzenesulfonamido, p-toluenesulfonamido, octadecanesulfonamido); a carbamoyl group (e.g., N-ethylcarbamoyl, N,N-dibutylcarbamoyl); a sulfamoyl group (e.g., N-ethylsulfamoyl, N,N-dipropylsulfamoyl, N,N-diethylsulfamoyl); a sulfonyl group (e.g., methanesulfonyl, octanesulfonyl, benzenesulfonyl, toluenesulfonyl); an alkyloxycarbonyl group (e.g., methoxycarbonyl, butyloxycarbonyl); a heterocyclic oxy group (e.g., 1-phenyltetrazol-5-oxy, 2-tetrahydropyranyloxy); an azo group (e.g., phenylazo, 4-methoxyphenylazo, 4-pivaloylaminophenylazo, 2-hydroxy-4-propanoylphenylazo); an acyloxy group (e.g., acetoxy); a carbamoyloxy group (e.g., N-methylcarbamoyloxy, N-phenylcarbamoyloxy); a silyloxy group (e.g., trimethylsilyloxy, dibutylmethylsilyloxy); an aryloxycarbonylamino group (e.g., phenoxycarbonylamino); an imido group (e.g., N-succinimido, N-phthalimido); a heterocyclic thio group (e.g., 2-benzothiazolylthio, 2,4-di-phenoxy-1,3,5-triazole-6-thio, 2-pyridylthio); a sulfinyl group (e.g., 3-phenoxypropylsulfinyl); a phosphonyl group (e.g., phenoxyphosphonyl, octyloxyphosphonyl, phenylphosphonyl); an aryloxycarbonyl group (e.g., phenoxycarbonyl); an acyl group (e.g., acetyl, 3-phenylpropanoyl, benzoyl); an ionic hydrophilic group (e.g., a carboxy group, a sulfo group, and a quaternary ammonium group); a cyano group; a hydroxy group; a nitro group; and an amino group are exemplified.

As the substituted or unsubstituted alkyl group represented by Z, V₁ or V₂, an alkyl group having from 1 to 30 carbon atoms is preferable. A branched alkyl group is preferable for the reason that solubility of the dye and stability of the ink can be increased, and the case of having an asymmetric carbon atom (the use as a racemic body) is especially preferable. Examples of the substituents include the substituents described for Z, V₁ and V₂. Among the substituents, a hydroxy group, an ether group, an ester group, a cyano group, an amino group, an amido group, and a sulfonamido group are preferable for the reason of capable of improving an associating property and fastness of the dye. Besides the above, the substituted or unsubstituted alkyl group represented by Z, V₁ or V₂ may have a halogen atom or an ionic hydrophilic group.

As the substituted or unsubstituted cycloalkyl group represented by Z, V₁ or V₂, a cycloalkyl group having from 5 to 30 carbon atoms is preferable. The case of having an asymmetric carbon atom (the use as a racemic body) is preferable from the points that solubility of the dye and stability of the ink can be increased. Examples of the substituents include the substituents described for Z, V₁ and V₂. Among the substituents, a hydroxy group, an ether group, an ester group, a cyano group, an amino group, an amido group, and a sulfonamido group are preferable for the reason of capable of improving an associating property and fastness of the dye. Besides the above, the substituted or unsubstituted cycloalkyl group represented by Z, V₁ or V₂ may have a halogen atom or an ionic hydrophilic group.

As the substituted or unsubstituted alkenyl group represented by Z, V₁ or V₂, an alkenyl group having from 2 to 30 carbon atoms is preferable. A branched alkenyl group is preferable for the reason that solubility of the dye and stability of the ink can be increased, and the case of having an asymmetric carbon atom (the use as a racemic body) is especially preferable. Examples of the substituents include the substituents described for Z, V₁ and V₂. Among the substituents, a hydroxy group, an ether group, an ester group, a cyano group, an amino group, an amido group, and a sulfonamido group are preferable for the reason of capable of improving an associating property and fastness of the dye. Besides the above, the substituted or unsubstituted alkenyl group represented by Z, V₁ or V₂ may have a halogen atom or an ionic hydrophilic group.

As the substituted or unsubstituted alkynyl group represented by Z, V₁ or V₂, an alkynyl group having from 2 to 30 carbon atoms is preferable. A branched alkynyl group is preferable for the reason that solubility of the dye and stability of the ink can be increased, and the case of having an asymmetric carbon atom (the use as a racemic body) is especially preferable. Examples of the substituents include the substituents described for Z, V₁ and V₂. Among the substituents, a hydroxy group, an ether group, an ester group, a cyano group, an amino group, an amido group, and a sulfonamido group are preferable for the reason of capable of improving an associating property and fastness of the dye. Besides the above, the substituted or unsubstituted alkynyl group represented by Z, V₁ or V₂ may have a halogen atom or an ionic hydrophilic group.

As the substituted or unsubstituted aralkyl group represented by Z, V₁ or V₂, an aralkyl group having from 7 to 30 carbon atoms is preferable. A branched aralkyl group is preferable for the reason that solubility of the dye and stability of the ink can be increased, and the case of having an asymmetric carbon atom (the use as a racemic body) is especially preferable. Examples of the substituents include the substituents described for Z, V₁ and V₂. Among the substituents, a hydroxy group, an ether group, an ester group, a cyano group, an amino group, an amido group, and a sulfonamido group are preferable for the reason of capable of improving an associating property and fastness of the dye. Besides the above, the substituted or unsubstituted aralkyl group represented by Z, V₁ or V₂ may have a halogen atom or an ionic hydrophilic group.

As the substituted or unsubstituted aryl group represented by Z, V₁ or V₂, an aryl group having from 6 to 30 carbon atoms is preferable. Examples of the substituents include the substituents described for Z, V₁ and V₂. Above all, an electron-attracting group is preferable for the reason of capable of making an oxidation potential of the dye noble and improving fastness.

As the heterocyclic group represented by Z, V₁ or V₂, 5- or 6-membered rings are preferable, and they may be further condensed. The heterocyclic group may be a group derived from an aromatic heterocycle or a non-aromatic heterocycle. The heterocyclic groups represented by Z, V₁ or V₂ are shown in the form of a heterocycle omitting the positions of substitution. The positions of substitution are not restricted and, for example, pyridine can be substituted at the 2-, 3- and 4-positions. Examples of the heterocyclic group include, pyridine, pyrazine, pyrimidine, pyridazine, triazine, quinoline, isoquinoline, quinazoline, cinnoline, phthalazine, quinoxaline, pyrrole, indole, furan, benzofuran, thiophene, benzothiophene, pyrazole, imidazole, benzimidazole, triazole, oxazole, benzoxazole, thiazole, benzothiazole, isothiazole, benzisothiazole, thiadiazole, isoxazole, benzisoxazole, pyrrolidine, piperidine, piperazine, imidazolidine, and thiazoline. Aromatic heterocyclic groups are preferable, and the preferable examples are shown below similarly to the above, e.g., pyridine, pyrazine, pyrimidine, pyridazine, triazine, pyrazole, imidazole, benzimidazole, triazole, thiazole, benzothiazole, isothiazole, benzisothiazole, and thiadiazole. Each of them may have a substituent, and examples of the substituents include the substituents described for Z, V₁ and V₂. The preferable substituents are the same as the preferable substituents of the aryl group, and more preferable substituents are the same as the more preferable substituents of the aryl group, respectively.

When the phthalocyanine dye of the invention is water-soluble, it is preferable to have an ionic hydrophilic group. Examples of the ionic hydrophilic groups include a sulfo group, a carboxy group, a phosphono group and a quaternary ammonium group. As the ionic hydrophilic groups, a carboxy group, a phosphono group, and a sulfo group are preferable, and a carboxy group and a sulfo group are especially preferable. The carboxy group, phosphono group and sulfo group may take the state of a salt. Examples of counter ions to form a salt include an ammonium ion, an alkali metal ion (e.g., a lithium ion, a sodium ion, a potassium ion) and an organic cation (e.g., a tetramethylammonium ion, a tetramethylguanidinium ion, a tetramethylphosphonium ion). Among the counter ions, alkali metal salts are preferable, and lithium salts are especially preferable from the points of heightening solubility of dyes and improving stability of inks The most preferable ionic hydrophilic group is a lithium salt of a sulfo group.

As for the number of ionic hydrophilic groups, it is preferrable to have at least two in one molecule of the phthalocyanine dye, and it is especially preferable to have at least two sulfo groups and/or carboxy groups.

As M, a hydrogen atom, and, as the metal atoms, Li, Na, K, Mg, Ti, Zr, V, Nb, Ta, Cr, Mo, W, Mn, Fe, Co, Ni, Ru, Rh, Pd, Os, Ir, Pt, Cu, Ag, Au, Zn, Cd, Hg, Al, Ga, In, Si, Ge, Sn, Pb, Sb, Bi and the like are exemplified. As the metal oxides, VO, GeO and the like are exemplified. As the metal hydroxides, Si(OH)₂, Cr(OH)₂, Sn(OH)₂ and the like are exemplified. Further, as the metal halides, AlCl, SiCl₂, VCl, VCl₂, VOCl, FeCl, GaCl, ZrCl and the like are exemplified. Among the above, Cu, Ni, Zn and Al are especially preferable as M, and Cu is most preferable.

A phthalocyanine ring (Pc) may form a dimer (e.g., Pc-M-L-M-Pc) or a trimer via L (a divalent linking group), and M at that time may be the same or different from each other.

The divalent linking group represented by L is preferably an oxy group (—O—), a thio group (—S—), a carbonyl group (—CO—), a sulfonyl group (—SO₂—), an imino group (—NH—), a methylene group (—CH₂—), or a group formed by combination of these divalent linking groups.

As the chemical structure of the phthalocyanine dye in the invention, it is especially preferable to introduce an electron-attracting group such as a sulfinyl group (—SO—Z), a sulfonyl group (—SO₂—Z), a sulfamoyl group (—SO₂NV₁V₂), a carbamoyl group (—CONV₁V₂), an alkoxycarbonyl group, an aryloxycarbonyl group, a heterocyclic oxycarbonyl group (—CO₂Z), an acyl group (—CO—Z), or a sulfo group, at least one to every benzene ring of the phthalocyanine dye in the invention, so that the total of σp value of the substituents of the phthalocyanine structure reaches of 1.2 or more. Among the above electron-attracting groups, a sulfinyl group (—SO—Z), a sulfonyl group (—SO₂—Z), and a sulfamoyl group (—SO₂NV₁V₂) are preferable, a sulfonyl group (—SO₂—Z) and a sulfamoyl group (—SO₂NV₁V₂) are more preferable, and a sulfonyl group (—SO₂—Z) is most preferable.

Hammett's substitutent constant σₚ value will be described briefly below. Hammett's rule is a rule of thumb advocated by L. P. Hammett in 1935 to discuss quantitatively the influence of a substituent on the reaction or equilibrium of a benzene derivative, and the validity of which is widely recognized today. There are a σₚ value and a σₘ value in the substituent constant required of Hammett's rule, and these values can be found in various ordinary publications, and described in detail in, for example, compiled by J. A. Dean, Lange's Handbook of Chemistry, 12^{th} Edition, McGraw-Hill (1979), and Kagaku no Ryoiki (The Region of Chemistry), Extra Issue, No. 122, pages 96-103, Nankodo Co., Ltd. (1979).

With respect to preferable combinations of X₁, X₂, X₃, X₄, Y₁, Y₂, Y₃, Y₄, a₁, a₂, a₃, a₄, b₁, b₂, b₃, b₄ and M in the compound represented by Formula (C-1), the compound in which at least one of various groups is the above preferable group is preferable, the compound in which various more groups are the above preferable groups is more preferable, and the compound in which all the groups are the above preferable groups is most preferable.

A cyan-based dye used as the colorant, among the water-soluble phthalocyanine dye represented by Formula (C-1), a compound selected from the group consisting of a compound represented by the following Formula (C-2) and salts thereof is preferable.

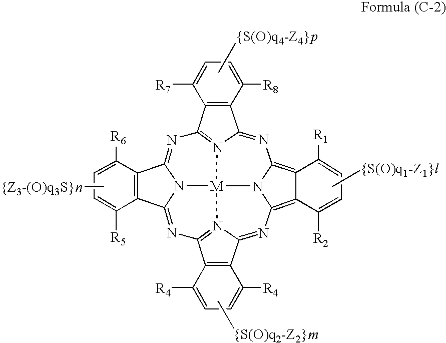

In Formula (C-2), each of R₁, R₂, R₃, R₄, R₅, R₆, R₇ and R₈ independently represents a hydrogen atom, a halogen atom, an alkyl group, a cycloalkyl group, an alkenyl group, an aralkyl group, an aryl group, a heterocyclic group, a cyano group, a hydroxy group, a nitro group, an amino group, an alkylamino group, an alkoxy group, an aryloxy group, an amido group, an arylamino group, a ureido group, a sulfamoylamino group, an alkylthio group, an arylthio group, an alkoxycarbonylamino group, a sulfonamido group, a carbamoyl group, a sulfamoyl group, a sulfinyl group, a sulfonyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imido group, a heterocyclic thio group, a phosphoryl group, an acyl group, or an ionic hydrophilic group, and these groups may further have a substituent.

Each of Z₁, Z₂, Z₃ and Z₄ independently represents a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group, provided that at least one of Z₁, Z₂, Z₃ or Z₄ has an ionic hydrophilic group as the substituent.

In Formula (C-2), each of l, m, n, p, q₁, q₂, q₃ and q₄ independently represents 1 or 2. M has the same meaning as in Formula (C-1), and preferable examples thereof are also the same.

Concerning l, m, n and p, two or more of l, m, n and p preferably represent 1, and most preferably l=m=n=p=1.

Concerning q₁, q₂, q₃ and q₄, two or more of q₁, q₂, q₃ and q₄ preferably represent 2, and most preferably q₁=q₂=q₃=q₄=2.

Each of Z₁, Z₂, Z₃ and Z₄ independently represents preferably a substituted or unsubstituted alkyl group, a substituted or unsubstituted aryl group, or a substituted or unsubstituted heterocyclic group, more preferably a substituted alkyl group, a substituted aryl group, or a substituted heterocyclic group, and most preferably a substituted alkyl group, provided that at least one of Z₁, Z₂, Z₃ or Z₄ has an ionic hydrophilic group as the substituent.

Each of R₁, R₂, R₃, R₄, R₅, R₆, R₇ and R₈ independently represents preferably a hydrogen atom, a halogen atom, an alkyl group, an aryl group, a heterocyclic group, a cyano group, a hydroxy group, a nitro group, a carbamoyl group, a sulfamoyl group, a sulfinyl group, a sulfonyl group, an alkoxycarbonyl group, an aryloxycarbonyl group, a phosphoryl group, an acyl group, or an ionic hydrophilic group; more preferably a hydrogen atom, a halogen atom, a cyano group, a hydroxy group, a sulfamoyl group, a sulfinyl group, a sulfonyl group, or an ionic hydrophilic group; and particularly preferably a hydrogen atom.

As for the preferable combination of R₁, R₂, R₃, R₄, R₅, R₆, R₇, R₈, Z₁, Z₂, Z₃, Z₄, l, m, n, p, q₁, q₂, q₃ and q₄ of the compound represented by Formula (C-2), a compound in which at least one of various groups is the above mentioned preferable group is preferable, a compound in which a larger number of various groups are the above mentioned preferable groups is more preferable, and a compound in which all the groups are the above mentioned preferable groups is most preferable.

In Formula (C-2), a case where each of R₁, R₂, R₃, R₄, R₅, R₆, R₇, and R₈ independently represents a hydrogen atom, a halogen atom, a cyano group, a hydroxy group, a sulfamoyl group, a sulfinyl group, a sulfonyl group, or an ionic hydrophilic group, and more preferably a hydrogen atom; each of Z₁, Z₂, Z₃ and Z₄ independently represents a substituted alkyl group, a substituted aryl group, or a substituted heterocyclic group, and more preferably a substituted alkyl group; l=m=n=p=1; q₁=q₂=q₃=q₄=2; and M represents Cu, Ni, Zn, or Al, and more preferably Cu, is preferable.

As a cyan-based dye used as the colorant, among the compound and salts thereof represented by Formula (C-2), a compound selected from the group consisting of a compound represented by the following Formula (C-3) and salts thereof is more preferable.

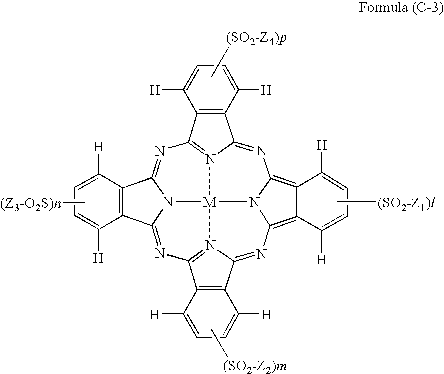

In Formula (C-3), Z₁, Z₂, Z₃, Z₄, l, m, n, p and M respectively have the same meaning as Z₁, Z₂, Z₃, Z₄, l, m, n, p and M in Formula (C-2), and preferable examples thereof are also the same.

In Formula (C-3), each of l, m, n and p independently represents 1 or 2, preferably two or more of l, m, n and p represent 1, and most preferably l=m=n=p=1.

In Formula (C-3), each of Z₁, Z₂, Z₃ and Z₄ independently represents a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group, preferably a substituted or unsubstituted alkyl group, a substituted or unsubstituted aryl group, or a substituted or unsubstituted heterocyclic group, more preferably a substituted alkyl group, a substituted aryl group, or a substituted heterocyclic group, and most preferably a substituted alkyl group.

In detail, each of Z₁, Z₂, Z₃ and Z₄ independently represents preferably —(CH₂)₃SO₃M₂, (referred to as Z₁₁, here M₂ represents an alkali metal atom) or —(CH₂)₃SO₂NHCH₂CH(OH)CH₃) (referred to as Z₁₂). In particular, a dye mixture in which the molar ratio of Z₁₁ to Z₁₂ contained in the compound represented by Formula (C-3) at a value of Z₁₁/Z₁₂ is 4/0, 3/1, 2/2, or 1/3 is preferable, and a dye mixture mainly comprising Z₁₁/Z₁₂ of 3/1 or 2/2 are most preferable, provided that at least one of Z₁, Z₂, Z₃ and Z₄ has an ionic hydrophilic group as the substituent. Herein, “mainly comprising” is referred to comprising 50% or more in the dye mixture. In the above, a case where each of Z₁, Z₂, Z₃ and Z₄ independently represents a substituted alkyl group, a substituted aryl group, or a substituted heterocyclic group (and more preferably a substituted alkyl group), l=m=n=p=1, and M represents Cu, Ni, Zn or Al (and more preferably Cu), is preferable.

In the above, M₂ in the group of —(CH₂)₃SO₃M₂ represented by Z₁₁, is preferably Li, Na or K, and is particularly preferably Li.

As for the preferable combination of Z₁, Z₂, Z₃, Z₄, l, m, n, p or M of the compound represented by Formula (C-3), a compound in which at least one of various groups is the above mentioned preferable group is preferable, a compound in which a larger number of various groups are the above mentioned preferable groups is more preferable, and a compound in which all the groups are the above mentioned preferable groups is most preferable.

A content of the water-soluble phthalocyanine dye represented by Formula (C-1) contained in the cyan ink is determined depending upon the kinds of X₁ to X₄ and Y₁ to Y₄ in Formula (C-1), and the kinds of the solvent components used in the manufacture of the ink, but it is preferable in the invention that the water-soluble phthalocyanine dye represented by Formula (C-1) is contained in the cyan ink in an amount of from 1% by mass to 10% by mass with respect to the total mass of the cyan ink, and more preferably from 2% by mass to 6% by mass.

By making the amount of the water-soluble phthalocyanine dye represented by Formula (C-1) contained in the cyan ink be 1% by mass or more in total, a coloring property of the ink on a recording medium when recorded can be made good, and required image density can be secured. Further, by making the amount of the water-soluble phthalocyanine dye represented by Formula (C-1) contained in the cyan ink be 10% by mass or less in total, good jetting of the cyan ink can be attained when used in an inkjet recording method, and the effect that the nozzles are difficult to be clogged can be obtained, which are advantageous.

As preferable specific examples of the dyes represented by Formula (C-1), the compounds described in JP-A No. 2007-138124, paragraphs [0582] to [0652] are exemplified.

In the invention, other cyan dyes than the water-soluble phthalocyanine dye represented by Formula (C-1) may be used, for example, in order to adjust a color tone of the cyan ink.

Among the colorants, the pigment is not specifically limited, and either an inorganic or organic pigment may be used.

As the inorganic pigment, titanium oxide and iron oxide, as well as carbon black prepared by a known method such as a contact process, furnace process or thermal process may be used.

As the organic pigment, azo pigments (e.g., azo lake, insoluble azo pigments, condensed azo pigments, chelate azo pigments and the like), polycyclic pigments (e.g., phthalocyanine pigments, perylene pigments, perynone pigments, anthraquinone pigments, quinacridone pigments, dioxazine pigments, thioindigo pigments, isoindolinone pigments, quinophthalone pigment and the like), dye chelates (e.g., basic dye chelates, acidic dye chelates and the like), nitro pigments, nitroso pigments, aniline black and the like may be used.

These pigment may be added to the ink as a pigment dispersion liquid obtained by dispersing the pigment in an aqueous medium using a dispersing agent or a surfactant. As the dispersing agent, dispersing agents that are conventionally used for preparing a pigment dispersion liquid such as polymer dispersing agents may be used.

As the ink used in the invention, an embodiment comprising an cyan ink including at least one kind of the water-soluble phthalocyanine dyes represented by Formulas (C-1) and an aqueous medium is preferable. By performing recording using a combination of this cyan ink and the inkjet recording medium of the invention as mentioned above, the suppression of generation of bronzing, surface state and water resistance of the image may further be improved.

When necessary, the ink may include other additives besides the colorant to the extent that the effect of the invention is not deteriorated.

Examples of the other additives may include known additives such as boron compounds, drying inhibitors (wetting agents), discoloration inhibitors, emulsion stabilizers, penetration enhancers, ultraviolet absorbents, preservatives, fungicides, pH adjusting agents, surface tension adjusting agents, defoaming agents, viscosity adjusting agents, dispersing agents, dispersion stabilizers, antirusts and chelating agents.

The aqueous medium includes water as a main component, and when necessary, a mixture with a water-miscible organic solvent may be used. Examples of the water-miscible organic solvent include alcohols (e.g., methanol, ethanol, propanol, isopropanol, butanol, isobutanol, sec-butanol, t-butanol, pentanol, hexanol, cyclohexanol, and benzyl alcohol), polyhydric alcohols (e.g., ethylene glycol, diethylene glycol, triethylene glycol, polyethylene glycol, propylene glycol, dipropylene glycol, polypropylene glycol, butylene glycol, hexanediol, pentanediol, glycerine, hexanetriol, and thiodiglycol), glycol derivatives (e.g., ethylene glycol monomethyl ether, ethylene glycol monoethyl ether, ethylene glycol monobutyl ether, diethylene glycol monomethyl ether, diethylene glycol monobutyl ether, propylene glycol monomethyl ether, propylene glycol monobutyl ether, dipropylene glycol monomethyl ether, triethylene glycol monomethyl ether, ethylene glycol diacetate, ethylene glycol monomethyl ether acetate, triethylene glycol monomethyl ether, triethylene glycol monoethyl ether, and ethylene glycol monophenyl ether), amines (e.g., ethanolamine, diethanolamine, triethanolamine, N-methyldiethanolamine, N-ethyldiethanolamine, morpholine, N-ethylmorpholine, ethylenediamine, diethylenetriamine, triethylenetetramine, polyethyleneimine, and tetramethylpropylenediamine), and other polar solvents (e.g., formamide, N,N-dimethylformamide, N,N-dimethylacetamide, dimethylsulfoxide, sulfolane, 2-pyrrolidone, N-methyl-2-pyrrolidone, N-vinyl-2-pyrrolidone, 2-oxazolidone, 1,3-dimethyl-2-imidazolidinone, acetonitrile, and acetone). Two or more of the water-miscible organic solvents may be used in combination.

The drying inhibitor may prevent the ink jetting outlet of the nozzle used in the inkjet recording system from clogging due to drying of the ink. As the drying inhibitor, a water-soluble organic solvent having a vapor pressure lower than that of water is preferable.

Specific examples of the drying inhibitor include polyhydric alcohols such as ethylene glycol, propylene glycol, diethylene glycol, polyethylene glycol, thiodiglycol, dithiodiglycol, 2-methyl-1,3-propanediol, 1,2,6-hexanetriol, acetylene glycol derivatives, glycerine and trimethylolpropane; lower alkyl ethers of polyhydric alcohols such as ethylene glycol monomethyl (or ethyl)ether, diethylene glycol monomethyl (or ethyl)ether and triethylene glycol monoethyl (or butyl)ether; heterocycles such as 2-pyrrolidone, N-methyl-2-pyrrolidone, 1,3-dimethyl-2-imidazolidinone and N-ethylmorpholine; sulfur-containing compounds such as sulfolane, dimethylsulfoxide and 3-sulfolene; polyfunctional compounds such as diacetone alcohol and diethanolamine; and urea derivatives.

Among these, polyhydric alcohols such as glycerine and diethylene glycol are more preferable. The drying inhibitors may be used solely or in a combination of two or more of them. It is preferable that the drying inhibitor is included in the ink in an amount of from 10% by mass to 50% by mass.

The penetration enhancer allows better penetration of the ink to paper. Examples of the penetration enhancer may include alcohols such as ethanol, isopropanol, butanol, diethylene glycol monobutyl ether, triethylene glycol monobutyl ether and 1,2-hexanediol, sodium lauryl sulfate, sodium oleate, nonionic surfactants, and the like.

Generally, a sufficient effect may be obtained by incorporating the penetration enhancer into the ink in a range of from 5% by mass to 30% by mass. It is preferable that the penetration enhancer is used in the range of the amount at which the blurring of the image and print through are not generated.

The ultraviolet absorbent may improve storability of the image. Examples of the ultraviolet absorbent may include the benzotriazole compounds described in JP-A Nos. 58-185677, 61-190537, 2-782, 5-197075, 9-34057 and the like; the benzophenone compounds described in JP-A Nos. 46-2784, 5-194483 and U.S. Pat. No. 3,214,463 and the like; the cinnamic acid compounds described in JP-B Nos. 48-30492 and 56-21141, JP-A No. 10-88106 and the like; the triazine compounds described in JP-A Nos. 4-298503, 8-53427, 8-239368 and 10-182621, Japanese National Phase Publication No. 8-501291, and the like; the compounds described in the Research Disclosure No. 24239; and the compounds that absorb ultraviolet rays and generate fluorescence such as stilbene compounds and benzoxazole compounds, so-called fluorescent whitening agents.

The discoloration inhibitor may improve storability of the image. As the discoloration inhibitor, various organic and metal complex discoloration inhibitors may be used. Examples of the organic discoloration inhibitor may include hydroquinones, alkoxyphenols, dialkoxyphenols, phenols, anilines, amines, indanes, chromanes, alkoxyanilines, thioethers, thioureas (examples of the thioethers and thioureas are described in JP-A No. 2002-36717, and examples of thioethers are described in JP-A No. 2002-86904), heterocycles and the like, and examples of the metal complex discoloration inhibitor include nickel complexes, zinc complexes and the like. More specifically, the compounds described in the patents cited by the Research Disclosure Nos. 17643 (Part VII, Sections Ito J), 15162, 18716 (page 650, left column), 36544 (page 527), 307105 (page 872) and 15162; and the compounds included in the formulas and compound examples of the representative compounds described in page 127 to page 137 of JP-A No. 62-215272 may be used.

Examples of the fungicide include sodium dehydroacetate, sodium benzoate, sodium pyridinethione-1-oxide, p-hydroxybenzoic acid ethyl ester and 1,2-benzisothiazolin-3-one, salts thereof, and the like. The fungicide is preferably included in the ink in a range of from 0.02% by mass to 1.00% by mass.

As the pH adjusting agent, a neutralizing agent (an organic base, an inorganic alkali) may be used. The pH adjusting agent is added so that the pH (at 25° C.) of the ink becomes preferably from 6 to 10, more preferably from 7 to 10, in order to improve storage stability of the ink.

Example of the surface tension adjusting agent includes nonionic, cationic or anionic surfactants.

The surface tension (at 25° C.) of the ink is preferably from 25 mN/m to 70 mN/m, and more preferably from 25 mN/m to 60 mN/m. The viscosity (at 25° C.) of the ink is preferably adjusted to 30 mPa·s or less, and more preferably 20 mPa·s or less.

Preferable examples of the surfactant include anionic surfactants such as fatty acid salts, alkyl sulfonate ester salts, alkylbenzene sulfonates, alkylnaphthalene sulfonates, dialkyl sulfosuccinates, alkylphosphate ester salts, naphthalene sulfonate formalin condensates, polyoxyethylenealkyl sulfonate ester salts; nonionic surfactants such as polyoxyethylene alkyl ethers, polyoxyethylene alkyl allyl ethers, polyoxyethylene fatty acid esters, sorbitan fatty acid esters, polyoxyethylene sorbitan fatty acid esters, polyoxyethylene alkyl amines, glycerine fatty acid esters and oxyethylene-oxypropylene block copolymers. Furthermore, SURFYNOLS (trade name, manufactured by AirProducts & Chemicals), which is an acetylene polyoxyethylene oxide surfactant, is also preferably used. Moreover, amphoteric surfactants such as amine oxide surfactants such as N,N-dimethyl-N-alkylamine oxide, and quaternary ammonium salt-containing betaine surfactants such as N,N-dimethyl-N-laurylcarbomethyl ammonium are also preferable. In addition, the surfactants described in JP-A No. 59-157636 (pages (37) and (38)) and the Research Disclosure No. 308119 (1989) may also be used.

Examples of the defoaming agent may include fluorine-containing compounds and silicone compounds. When necessary, chelate agents such as EDTA may be used.

The method for preparing the ink is not specifically limited, and descriptions of JP-A Nos. 5-148436, 5-295312, 7-97541, 7-82515, 7-118584 and 2004-331871 may be applied.

The ink of the invention may be used, for example, for an ink set including a yellow ink including a yellow dye, a cyan ink including a cyan dye, and a magenta ink including a magenta dye.

The yellow dye is not specifically limited, and examples of the yellow dye may include those described in JP-A No. 2007-70573, paragraphs [0025] to [0040] and the like. The cyan dye is not specifically limited, and examples of the cyan dye may include those described in JP-A No. 2007-70753, paragraphs [0083] to [0090] and the like. The magenta dye is not specifically limited, and examples of the magenta dye may include ones in which the water-soluble group is only a sulfonic acid group and the counter ion is Li⁺ ion or a quaternary ammonium ion, among the water-soluble dyes described in WO2002/83795 (pages 35 to 55), WO2002/83662 (pages 27 to 42), JP-A No. 2004-149560 (paragraphs [0046] to [0059]) and JP-A No. 2004-149561 (paragraphs [0047] to [0060]).

### EXAMPLES

Hereinafter the invention is explained with referring to Examples, but the invention is not limited thereto unless the invention departs from its purport. In the following Examples, the “part(s)” and “%” refer to “part(s) by mass” and “% by mass” respectively, unless specifically mentioned.

### Example 1

### Preparation of Inkjet Recording Medium

### (Preparation of Support)

Wood pulp including LBKP (100 parts) was beaten up to the Canadian Freeness of 300 mL using a double disc refiner. Epoxylated behenic acid amide (0.5 parts), anionic polyacrylamide (1.0 parts), polyamide polyamine epichlorohydrin (0.1 parts) and cationic polyacrylamide (0.5 parts) were added, all by an absolute dry mass ratio with respect to the pulp, and the amount was measured by a Fortlinear paper machine to give a base paper of 170 g/m².

In order to adjust the surface size of the base paper, a fluorescent whitening agent (trade name: WHITEX BB, manufactured by Sumitomo Chemical Co., Ltd.) (0.04%) was added to a 4% aqueous polyvinyl alcohol solution, with which the base paper was impregnated so that the absolute dry weight equivalent became 0.5 g/m². The paper was dried and further subjected to a calender treatment to give a substrate paper in which the density had been adjusted to 1.05.

The wire surface (back surface) of the obtained substrate paper was subjected to a corona discharge treatment, and high density polyethylene was applied thereon so that its thickness became 19 μm using a melt extruder to form a resin layer including a matte surface (hereinafter this resin layer surface is referred to as “back surface”). The back resin layer was further subjected to a corona discharge treatment, and a dispersion liquid in which aluminum oxide (trade name: ALUMNA SOL 100, manufactured by Nissan Chemical Industries, Ltd.) and silicone dioxide (trade name: SNOWTEX 0, manufactured by Nissan Chemical Industries, Ltd.), as antistatic agents, had been dispersed in water in a mass ratio of 1:2 was applied so that the dry weight became 0.2 g/m².

Furthermore, the felt surface (front surface) on which the resin layer had not been provided was subjected to a corona discharge treatment. Low density polyethylene including anatase titanium dioxide (10%), ultramarine blue (trace amount), and a fluorescent whitening agent (0.01%) (with respect to polyethylene) and having an MFR (melt flow rate) of 3.8 was melt extruded using a melt extruder so that the thickness thereof became 29 μm to form a thermoplastic resin layer having a high gloss on the front surface of the substrate paper (hereinafter this high gloss surface is referred to as “front surface”) to give a support used in this Example.

(Preparation of Coating Solution for Ink Receiving Layer)

The (1) vapor-phase process silica fine particles, (2) ion exchanged water, (3) SHAROLL DC-902P (trade name) and (4) ZA-30 (trade name) shown in the composition mentioned below were mixed and dispersed using a liquid-liquid collision type dispersing machine (trade name: ULTIMIZER, manufactured by Sugino Machine Limited), and the obtained dispersion liquid was heated to 45° C. and maintained for 20 hours. Thereafter (5) polyvinyl alcohol solution, (6) SUPERFLEX 650 (trade name), (7) boric acid, and (8) 30% aqueous solution of methionine sulfoxide were added to the dispersion liquid at 30° C. to prepare a coating solution for the ink receiving layer. The mass ratio of the silica fine particles to the water-soluble resin [PB ratio=(1):(5)] was 4.0:1. The pH of the coating solution for the ink receiving layer was 3.4, which means an acidic solution.

<Composition of Coating Solution>

| | |
|---|---|
| (1) Vapor-phase process silica fine particles | 8.9 parts |
| (inorganic fine particles) | |
| [trade name: AEROSIL300SF75, manufactured by Nippon | |
| Aerosil Co., Ltd.] | |
| (2) Ion exchanged water | 55.6 parts |
| (3) dimethyldiallylammonium chloride | 0.78 parts |
| [trade name: SHAROLL DC-902P, manufactured by Dai-ichi | |
| Kogyo Seiyaku Co., Ltd., dispersing agent; | |
| 51.5% aqueous solution] | |
| (4) Zirconyl acetate | 0.48 parts |
| [trade name: ZIRCOSOL ZA-30, manufactured by Daiichi | |
| Kigenso Kagaku Kogyou Co., Ltd.] | |
| (5) Polyvinyl alcohol (water-soluble resin) solution | 26.0 parts |

Composition of Polyvinyl Alcohol Solution

| | |
|---|---|
| PVA-235 | 1.8 parts |
| [trade name; manufactured by Kuraray Co., Ltd, | |
| saponification degree: 88%, polymerization degree: 3500] | |
| Ion exchanged water | 23.5 parts |
| Diethylene glycol monobutyl ether | 0.55 parts |
| [trade name: BUTYCENOL 20P, manufactured by Kyowa | |
| Hakko Chemical Co., Ltd.] | |
| Surfactant [trade name: EMULGEN 109P, manufactured | 0.1 parts |
| by Kao Corporation] | |
| (6) Nitrogen-containing organic cationic polymer | 2.2 parts |
| emulsion | |
| [trade name: SUPERFLEX 650, manufactured by Dai-ichi | |
| Kogyo Seiyaku Co., Ltd.] | |
| (7) Boric acid . | 0.48 parts |
| (8) Methionine sulfoxide (30% aqueous solution). | 0.88 parts |

(Formation of Ink Receiving Layer)

The front surface of the support was subjected to a corona discharge treatment, and thereafter, the coating solution for ink receiving layer was applied on the front surface using an extrusion die coater at the coating solution temperature of 38° C. to give a coated layer. The coating amount of the coating solution for ink receiving layer was adjusted to 200 g/m² and in-line mixed with the following in-line solution at a velocity of 16.3 g/m², and the mixture was applied.

<Composition of In-Line Solution>

| | |
|---|---|
| ALFINE 83 (trade name: manufactured by Taimei Chemicals | 4.0 parts |
| Co., Ltd.) | |
| Ion exchanged water | 5.8 parts |
| Dimethylamine-epichlorohydrin condensate | 0.2 parts |
| [trade name: HYMAX SC-507, manufactured by Hymo | |
| Co., Ltd.] | |

The coated layer formed by the coating was dried in a hot air drier at 80° C. (air velocity: from 3 m/sec to 8 m/sec) so that the solid content in the coated layer became 24%. During this drying, the coated layer was dried in a constant rate. Immediately after the drying, the coated layer was soaked in a solution including a basic compound having the following composition for 3 seconds to apply the solution at an amount of 13 g/m² on the coated layer, and further dried at 72° C. for 10 minutes (drying process) to form an ink receiving layer on the support.

<Composition of Solution Including Basic Compound>

| | |
|---|---|
| Boric acid | 0.65 parts |
| Ammonium carbonate (primary: manufactured by Kanto | 5.0 parts |
| Chemical Co., Inc.) | |
| Magnesium dichloride | 0.3 parts |
| [trade name: White NIGARI NS, manufactured by Naikai | |
| Engyou Co., Ltd.] | |
| Ion exchanged water | 88.1 parts |
| Polyoxyethylene lauryl ether (surfactant) | 6.0 parts |
| [trade name: EMULGEN 109P, manufactured by Kao | |
| Corporation, 10% aqueous solution, HLB value: 13.6] | |

According to the above-mentioned manner, an inkjet recording medium including an ink receiving layer having a dry film thickness of 35 μm on a support was obtained.

(Preparation of Inks)

Deionized water was added to the following components so that the whole amount became 1 L, and the solution was stirred for 1 hour at from 30° C. to 40° C. while heating. Thereafter the pH was adjusted to 9 with an aqueous potassium hydroxide solution (10 mol/L), and the solution was filtered under reduced pressure using a microfilter having an average pore size of 0.25 μm to prepare a light magenta ink.

<Composition of Light magenta ink>

| | |
|---|---|
| Compound (M-1) represented by the following structural | 7.5 g/L |
| formula (Magenta dye) | |
| Diethylene glycol | 50 g/L |
| Urea | 10 g/L |
| Glycerin | 200 g/L |
| Triethylene glycol monobutyl ether | 120 g/L |
| Triethanolamine | 6.9 g/L |
| Benzotriazole | 0.08 g/L |
| 2-Pyrrolidone | 20 g/L |
| SURFYNOL 465 (surfactant, trade name: manufactured by | 10.5 g/L |
| Air Products Japan) | |
| PROXE1 XL-2 (bactericide, trade name: manufactured | 3.5 g/L |
| by ICI Japan) | |

Furthermore, magenta ink, light cyan ink, cyan ink, yellow ink and black ink were prepared by changing the dye species and additives, in a manner substantially similar to that in the preparation of the light magenta ink, and the ink set 101 having the concentrations shown in the following Table 1 was prepared.

TABLE 1

| | Light | | Light | | | |
|---|---|---|---|---|---|---|
| | magenta | Magenta | cyan | Cyan | Yellow | Black |
| Dye (g/L) | Compound | Compound | Compound | Compound | Compound | Compound Bk-1 |
| | M-1 | M-1 | C-1 | C-1 | Y-2 | (21.5) |
| | (7.5) | (30.0) | (8.75) | (35.0) | (29.0) | Compound Bk-2 |
| | | | | | | (5.5) |
| Diethylene glycol (g/L) | 50 | 80 | 170 | 110 | 90 | 10 |
| Urea (g/L) | 10 | 70 | — | — | — | — |
| Glycerin (g/L) | 200 | 150 | 170 | 150 | 150 | 160 |
| Triethylene glycol | 120 | 120 | 130 | 130 | 130 | — |
| monobutyl | | | | | | |
| ether (gL) | | | | | | |
| Diethylene glycol monobutyl | — | — | — | — | — | 110 |
| ether (g/L) | | | | | | |
| 2-Pyrrolidone (g/L) | 20 | — | — | — | — | 50 |
| SURFYNOL 465 (g/L) | 10.5 | 10 | 9.8 | 10.5 | — | — |
| SURFYNOL STG (g/L) | — | — | — | — | 8.5 | 9.8 |
| Triethanolamine (g/L) | 6.9 | 7 | 6 | 6 | 0.9 | 15 |
| Benzotriazole (g/L) | 0.08 | 0.07 | 0.08 | 0.08 | — | 0.06 |
| PROXEL XL2 (g/L) | 3.5 | 1.5 | 1.1 | 1.2 | 1.5 | 1.1 |

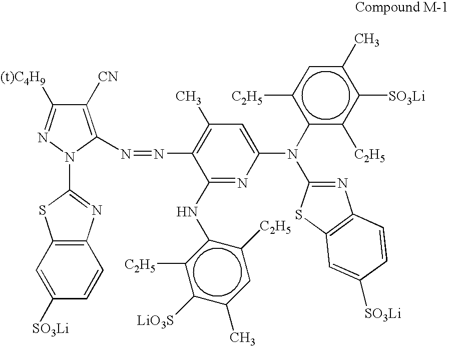

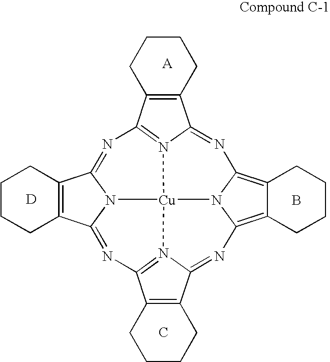

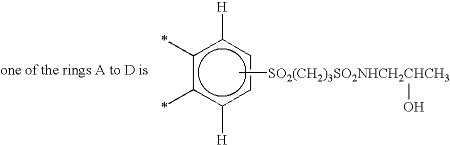

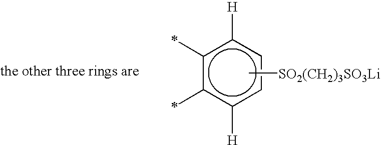

*represents the bonding position on the phthalocyanine ring

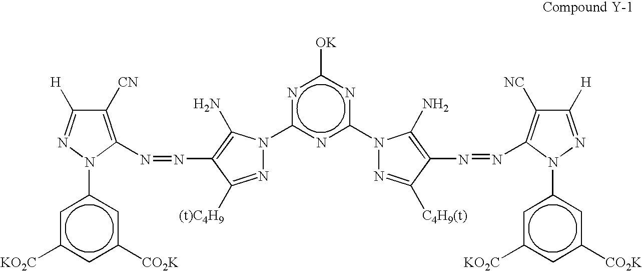

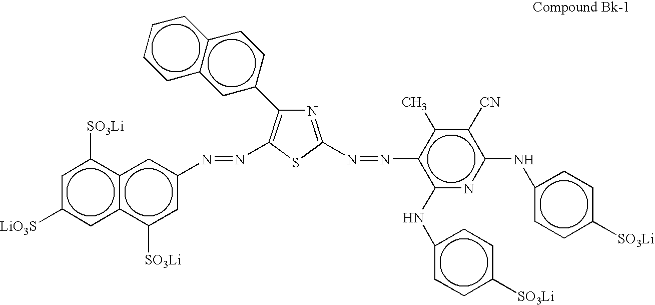

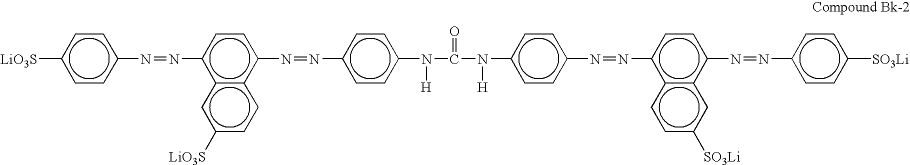

(Image Recording)

For the inkjet recording medium obtained as described above, an image was recorded as follows, using an inkjet printer (trade name: PM-A820, manufactured by Seiko Epson Corporation) equipped with the ink set 101 in place of a genuine ink set.

The inkjet recording medium was placed into a dryer at a temperature of 65° C. and a relative humidity of a few %, and stored at a low humidity for 5 minutes to dry it. Within 10 seconds from the timepoint at which the medium was taken out from the dryer (completion of low humidity storage), a blue solid image was printed on a 1 cm² region using the ink set 101. The environment at printing was a temperature of 35° C. and a relative humidity of 80%. Thereupon, a moisture amount of the ink receiving layer was 0.8 g/m², and a maximum ejection amount of the ink was 15 g/m².

Herein, in order to remove influence of moisture in the support, all sides of the support was covered up by lamination, an amount of moisture of the ink receiving layer was measured by a change in a weight when a sample was stored by changing the storage condition from a low humidity condition to a high humidity condition. It was assumed that no moisture substantially remains in the recording medium which has been dried at a temperature of 65° C. and a relative humidity of a few % for 5 minutes.

(Evaluation)

The blue solid image obtained as described above was evaluated as follows. Evaluation results are shown in Table 2 described below.

### —Bronzing—

An extent of bronzing of the image on the inkjet recording medium is visually observed, and ranked according to the following evaluation criteria.

### <Evaluation Criteria>

A: No occurrence of image bronzing is seen.
B: Bronzing is observed, but in a practically acceptable range.
C: Bronzing is observed, in a practically unacceptable range.

—Water Resistance—

One droplet of water was dropped on the recorded blue solid image, and allowed to stand under the conditions of 23° C. and 60% RH for one day, and the image was evaluated according to the following evaluation criteria.

### <Evaluation Criteria>

A: No blur of the image is observed.
B: Slight blur is observed.
C: Big blur is observed.

—Surface State—

At drying of the inkjet recording medium, the number of cracks occurred on a surface of the ink receiving layer was visually observed, and ranked according to the following evaluation criteria.

### <Evaluation Criteria>

A: No occurrence of a cracking is seen.
B: Cracks are observed, but to a small occurrence frequency.
C: Frequency of a cracking is high, in a practically unacceptable range.

### Example 2

In a manner substantially similar to that in Example 1 except that the time from completion of low humidity storage until printing in Example 1 was changed to 20 seconds, printing was performed, and the resulting blue solid image was evaluated in a similar manner to that in Example 1. Evaluation results are shown in Table 2 described below.

### Comparative Example 1

In a manner substantially similar to that in Example 1 except that the time from completion of low humidity storage to printing in Example 1 was changed to 45 seconds, printing was performed, and the resulting blue solid image was evaluated in a similar manner to that in Example 1. Evaluation results are shown in Table 2 described below.

### Comparative Example 2

In a manner substantially similar to that of Example 1 except that the addition amount of the polyvinyl alcohol-dissolved solution in Example 1 was changed from 31.2 parts to 50.4 parts, printing was performed, and the resulting blue solid image was evaluated in a similar manner to that in Example 1. Evaluation results are shown in Table 2 described below.

### Comparative Example 3

In a manner substantially similar to that of Example 1 except that the addition amount of the polyvinyl alcohol solution in Example 1 was changed from 31.2 parts to 22.9 parts, printing was performed, and the resulting blue solid image was evaluated in a similar manner to that in Example 1. Evaluation results are shown in the following Table 2.

TABLE 2

| | | Time from | | | | |
|---|---|---|---|---|---|---|
| | | completion | | | | |
| | | of low | | | | |
| | | humidity | Mois- | | | |
| | | condition | ture | | Water | |
| | P/B | until | amount | Bronz- | resis- | Surface |
| | ratio | printing (sec) | (g/m²) | ing | tance | state |
| Example 1 | 4.0 | 10 | 0.8 | A | A | A |
| Example 2 | 4.0 | 20 | 1.1 | B | A | A |
| Comparative | 4.0 | 45 | 1.4 | C | A | A |
| Example 1 | | | | | | |
| Comparative | 2.5 | 10 | 1.3 | C | A | A |
| Example 2 | | | | | | |
| Comparative | 2.5 | 10 | 0.6 | A | A | C |
| Example 3 | | | | | | |

As shown in the Table 2, in Examples, occurrence of bronzing at an image part was prevented, and water resistance and surface state of the image part were good. On the other hand, in Comparative Examples, bronzing occurred, or cracking occurred.

According to the invention, an inkjet recording method may be provided, using which a recorded image excellent in water resistance and good in surface state is obtained, and generation of bronzing of an image may be stably suppressed.

The present invention may namely provide the following items <1> to <10>.

<1> An inkjet recording method including ejecting an ink onto an ink receiving layer provided on a support to perform recording, wherein the ink receiving layer includes an inorganic fine particle (P) and a polyvinyl alcohol-based resin (B) at a content ratio (P/B; mass ratio) of from 3 to 5, and a water-soluble aluminum compound, and the ink receiving layer has a moisture amount at recording of 1.2 g/m² or less.
<2> The inkjet recording method of the item <1>, wherein the ink is ejected at a maximum total ink ejection amount of 15 g/m² or more.
<3> The inkjet recording method of the item <1> or <2>, wherein the ink includes at least a water-soluble phthalocyanine dye represented by the following Formula (C-1):

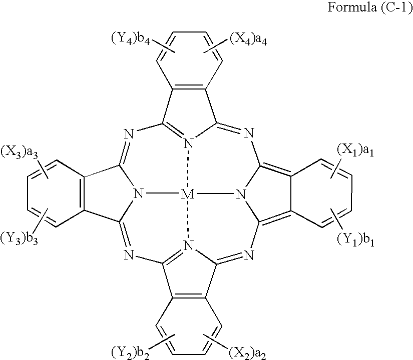

wherein, in Formula (C-1), each of X₁, X₂, X₃ and X₄ independently represents any of —SO—Z, —SO₂—Z, —SO₂NV₁V₂, —CONV₁V₂, —CO₂Z, —CO—Z, or a sulfo group; Z each independently represents an alkyl group, a cycloalkyl group, an alkenyl group, an alkynyl group, an aralkyl group, an aryl group, or a heterocyclic group; V₁ and V₂ each independently represent a hydrogen atom, an alkyl group, a cycloalkyl group, an alkenyl group, an alkynyl group, an aralkyl group, an aryl group, or a heterocyclic group; Y₁, Y₂, Y₃ and Y₄ each independently represent a hydrogen atom, a halogen atom, an alkyl group, a cycloalkyl group, an akenyl group, an aralkyl group, an aryl group, a heterocyclic group, a cyano group, a hydroxy group, a nitro group, an amino group, an alkylamino group, an alkoxy group, an aryloxy group, an amido group, an arylamino group, a ureido group, a sulfamoylamino group, an alkylthio group, an arylthio group, an alkoxycarbonylamino group, a sulfonamido group, a carbamoyl group, a sulfamoyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imido group, a heterocyclic thio group, a phosphoryl group, an acyl group, or an ionic hydrophilic group; a₁ to a₄ and b₁ to b₄ respectively represent numbers of X₁ to X₄ and Y₁ to Y₄; each of a₁ to a₄ independently represents an integer of from 0 to 4, provided that all of a₁ to a₄ do not represent 0 at the same time; each of b₁ to b₄ independently represents an integer of from 0 to 4; M represents a hydrogen atom, a metal atom or an oxide thereof, a hydroxide thereof, or a halide thereof; and at least one of X₁, X₂, X₃, X₄, Y₁, Y₂, Y₃ or Y₄ represents an ionic hydrophilic group, or a group having an ionic hydrophilic group as a substituent.

<4> The inkjet recording method of any one of items <1> to <3>, wherein the ink receiving layer further includes a crosslinking agent, and the ink receiving layer is a porous layer cured by a crosslinking reaction between the crosslinking agent, and a water-soluble resin containing the polyvinyl alcohol-based resin.
<5> The inkjet recording method of any one of items <1> to <4>, wherein the inorganic fine particle is selected from the group consisting of a silica fine particle, a colloidal silica, an alumina fine particle and pseudoboehmite.
<6> The inkjet recording method of any one of items <1> to <5>, wherein the inorganic fine particle is vapor-phase process silica, and the polyvinyl alcohol-based resin is a polyvinyl alcohol-based resin having a saponification degree of 70% to 100%.
<7> The inkjet recording method of any one of items <1> to <6>, wherein a solid matter content of the inorganic fine particle in the ink receiving layer is 50% by mass or more.
<8> The inkjet recording method of any one of items <1> to <7>, wherein the ink receiving layer further contains at least one nitrogen-containing organic cationic polymer.
<9> The inkjet recording method of the item <4>, wherein the crosslinking agent is a boron compound.
<10> The inkjet recording method of any one of items <1> to <9>, wherein the ink is ejected within 30 seconds after the ink receiving layer is dried to the extent that moisture does not substantially remain therein.

The foregoing description of the exemplary embodiments of the present invention has been provided for the purposes of illustration and description. It is not intended to be exhaustive or to limit the invention to the precise forms disclosed. The embodiments were chosen and described in order to best explain the principles of the invention and its practical applications, thereby enabling others skilled in the art to understand the invention for various embodiments and with the various modifications as are suited to the particular use contemplated.

All publications, patent applications, and technical standards mentioned in this specification are herein incorporated by reference to the same extent as if such individual publication, patent application, or technical standard was specifically and individually indicated to be incorporated by reference. It will be obvious to those having skill in the art that many changes may be made in the above-described details of the preferred embodiments of the present invention. It is intended that the scope of the invention be defined by the following claims and their equivalents.

What is claimed is:

1. An inkjet recording method comprising ejecting an ink onto an ink receiving layer provided on a support to perform recording, wherein the ink receiving layer comprises an inorganic fine particle (P) and a polyvinyl alcohol-based resin (B) at a content ratio (P/B; mass ratio) of from 3 to 5, and a water-soluble aluminum compound, and the ink receiving layer has a moisture amount at recording of 1.2 g/m² or less.

2. The inkjet recording method of claim 1, wherein the ink is ejected at a maximum total ink ejection amount of 15 g/m² or more.

3. The inkjet recording method of claim 1, wherein the ink comprises at least a water-soluble phthalocyanine dye represented by the following Formula (C-1): 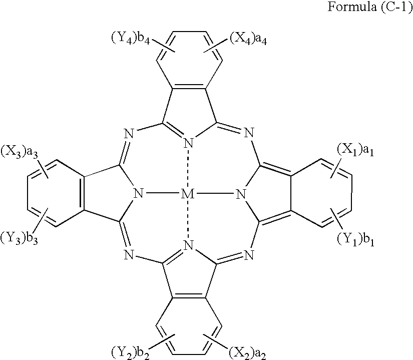
wherein, in Formula (C-1), each of X₁, X₂, X₃ and X₄ independently represents any of —SO—Z, —SO₂—Z, —SO₂NV₁V₂, —CONV₁V₂, —CO₂Z, —CO—Z, or a sulfo group; Z each independently represents an alkyl group, a cycloalkyl group, an alkenyl group, an alkynyl group, an aralkyl group, an aryl group, or a heterocyclic group; V₁ and V₂ each independently represent a hydrogen atom, an alkyl group, a cycloalkyl group, an alkenyl group, an alkynyl group, an aralkyl group, an aryl group, or a heterocyclic group; Y₁, Y₂, Y₃ and Y₄ each independently represent a hydrogen atom, a halogen atom, an alkyl group, a cycloalkyl group, an akenyl group, an aralkyl group, an aryl group, a heterocyclic group, a cyano group, a hydroxy group, a nitro group, an amino group, an alkylamino group, an alkoxy group, an aryloxy group, an amido group, an arylamino group, a ureido group, a sulfamoylamino group, an alkylthio group, an arylthio group, an alkoxycarbonylamino group, a sulfonamido group, a carbamoyl group, a sulfamoyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imido group, a heterocyclic thio group, a phosphoryl group, an acyl group, or an ionic hydrophilic group; a₁ to a₄ and b₁ to b₄ respectively represent numbers of X₁ to X₄ and Y₁ to Y₄; each of a₁ to a₄ independently represents an integer of from 0 to 4, provided that all of a₁ to a₄ do not represent 0 at the same time; each of b₁ to b₄ independently represents an integer of from 0 to 4; M represents a hydrogen atom, a metal atom or an oxide thereof, a hydroxide thereof, or a halide thereof; and at least one of X₁, X₂, X₃, X₄, Y₁, Y₂, Y₃ or Y₄ represents an ionic hydrophilic group, or a group having an ionic hydrophilic group as a substituent.

4. The inkjet recording method of claim 1, wherein the ink receiving layer further comprises a crosslinking agent, and the ink receiving layer is a porous layer cured by a crosslinking reaction between the crosslinking agent and a water-soluble resin containing the polyvinyl alcohol-based resin.

5. The inkjet recording method of claim 1, wherein the inorganic fine particle is selected from the group consisting of a silica fine particle, a colloidal silica, an alumina fine particle and pseudoboehmite.

6. The inkjet recording method of claim 1, wherein the inorganic fine particle is vapor-phase process silica, and the polyvinyl alcohol-based resin is a polyvinyl alcohol-based resin having a saponification degree of 70% to 100%.

7. The inkjet recording method of claim 1, wherein a solid matter content of the inorganic fine particle in the ink receiving layer is 50% by mass or more.

8. The inkjet recording method of claim 1, wherein the ink receiving layer further comprises at least one nitrogen-containing organic cationic polymer.

9. The inkjet recording method of claim 4, wherein the crosslinking agent is a boron compound.

10. The inkjet recording method of claim 1, wherein the ink is ejected within 30 seconds after the ink receiving layer is dried to the extent that moisture does not substantially remain therein.
